(19) United States
(12) Patent Application Publication
(10) Pub. No.: US 2026/0166719 A1
(43) Pub. Date: Jun. 18, 2026

(54) HUMANOID ROBOT WITH ADVANCED ACTUATOR

(71) Applicant: Figure AI Inc., San Jose, CA (US)

(72) Inventor: Shubham Jayprakash Chotia, San Jose, CA (US)

(21) Appl. No.: 19/329,474

(22) Filed: Sep. 15, 2025

Related U.S. Application Data
(63) Continuation-in-part of application No. 19/324,342, filed on Sep. 10, 2025, now abandoned.
(63) Continuation-in-part of application No. 19/296,525, filed on Aug. 11, 2025.
(60) Provisional application No. 63/694,287, filed on Sep. 13, 2024.
(60) Provisional application No. 63/807,975, filed on May 19, 2025.
(60) Provisional application No. 63/839,640, filed on Jul. 7, 2025.

(51) Int. Cl. B25J 9/12

(52) U.S. Cl. CPC B25J 9/126

(57) ABSTRACT

A humanoid robot comprises a torso, arm, and leg, with an actuator configured to actuate these components. The actuator includes a motor having a central axis and outer diameter, comprising a stator with a stator-support ring of multiple stator-support segments. At least one segment comprises stacked laminations interleaved with adhesive layers, where the laminations lack holes. The stator includes a winding-carrier ring with segments corresponding to stator-support segments, and electrical windings comprising conductive wire coils around portions of the stator-support segments. A rotor with magnets is positioned within the stator for rotation about the central axis. The actuator housing has an inner diameter smaller than the motor's outer diameter at ambient temperature, and thermally-conductive potting fills voids between the stator and housing.

This application is (i) a continuation in part of U.S. patent application Ser. No. 19/324,342 filed Sep. 10, 2025, (ii) a continuation in part of Ser. No. 19/296,525 filed Aug. 11, 2025, and (iii) claims the benefit of and priority to U.S. Provisional Patent Application Nos. 63/694,287 filed Sep. 13, 2024, 63/807,975 filed May 19, 2025, and 63/839,640 filed Jul. 7, 2025, each of which is expressly incorporated by reference herein in its entirety.

### TECHNICAL FIELD

The present disclosure relates generally to actuator motors, and more specifically to designing, manufacturing, and using an actuator motor, wherein said actuator is specifically designed for potential use in a general-purpose humanoid robot.

### BACKGROUND

The field of robotics, particularly humanoid robotics, is rapidly advancing, driven by progress in artificial intelligence, sensing, and materials science. This evolution prompts the design and implementation of increasingly sophisticated components capable of meeting demanding performance requirements as robots operate in complex, often human-centric environments. Actuators, as fundamental components providing motion and force, are very important to these advanced systems. However, conventional actuator designs often present significant limitations, especially when applied to humanoid robots where space and weight are primary constraints. Many existing actuators exhibit low torque density (or power density), are excessively large, and contribute significant weight, hindering their practical integration. Furthermore, inadequate thermal management capabilities frequently limit sustained high-performance operation, potentially leading to overheating, performance degradation, and reduced reliability in demanding scenarios.

The trend towards modular robotic architectures also highlights deficiencies in current actuator designs, which often lack the flexibility for seamless integration and customization, thereby increasing development complexity and cost. Additionally, as robots operate more closely with humans and for extended durations, factors like energy efficiency across various operating conditions and quieter operation become important for practicality, user acceptance, and achieving precise control. Accordingly, there is a clear and unmet need for an improved actuator design specifically addressing these challenges. Desirable advancements include significantly enhanced torque density and efficiency, superior thermal management, a modular construction approach facilitating integration and potentially simplifying manufacturing processes, reduced overall weight, and quieter operational characteristics to enable the next generation of capable and versatile humanoid robots.

### SUMMARY

The presently disclosed subject matter is directed to a humanoid robot comprising a humanoid shape including a torso, an arm, and a leg, and an actuator configured to actuate at least a portion of the torso, arm, or leg of the humanoid robot. The actuator comprises a motor having a central axis and an outer diameter surrounding the central axis. The motor comprises a stator comprising a stator-support ring comprising a plurality of stator-support segments, wherein at least one stator-support segment of the plurality of stator-support segments comprises a stacked layup of laminations interleaved with layers of adhesive, wherein the laminations lack holes formed therethrough, a winding-carrier ring comprising a plurality of winding-carrier segments, wherein each winding-carrier segment corresponds to a stator-support segment of the plurality of stator-support segments, and a collection of electrical windings, each electrical winding corresponding to a winding-carrier segment of the plurality of winding-carrier segments and comprising a coil of conductive wire arranged about a portion of the corresponding stator-support segment of the plurality of stator-support segments. The motor comprises a rotor positioned within the stator and configured to rotate therein about the central axis, wherein the rotor comprises magnets. The actuator comprises an actuator housing having an inner diameter that is smaller than the outer diameter of the motor at ambient temperature when the motor is not installed in the actuator housing, and a thermally-conductive potting that fills a majority of voids between the stator and the housing.

The presently disclosed subject matter is directed to a humanoid robot comprising a humanoid shape including a torso, arms, and legs, and an actuator configured to actuate a component of the humanoid robot. The actuator comprises a motor having a central axis and an outer diameter surrounding the central axis. The motor comprises a stator comprising a stator-support ring comprising a plurality of stator-support segments, wherein each stator-support segment of the plurality of stator-support segments comprises a protrusion extending circumferentially from the stator-support segment and configured to be received by a neighboring recess formed in a first adjacent stator-support segment, and a recess configured to receive a neighboring protrusion that extends circumferentially from a second adjacent stator-support segment, a winding-carrier ring comprising a plurality of winding-carrier segments, wherein each winding-carrier segment corresponds to a stator-support segment of the plurality of stator-support segments, and a collection of electrical windings, each electrical winding corresponding to a winding-carrier segment of the plurality of winding-carrier segments and comprising a coil of conductive wire arranged about a portion of the corresponding stator-support segment of the plurality of stator-support segments. The motor comprises a rotor positioned within the stator and configured to rotate therein about the central axis, wherein the rotor comprises magnets. The actuator comprises an actuator housing surrounding at least a portion of the motor and wherein an interference fit is formed between the housing and the motor when the motor is installed in the housing, and a thermally-conductive potting that fills a majority of voids between the stator and the housing.

The presently disclosed subject matter is directed to a stator for an electric motor. The stator comprises a plurality of stator-support segments coupled circumferentially to one another to form an annular stator-support ring around a central axis, a plurality of winding-carrier segments, each corresponding to one of the plurality of stator-support segments, and a plurality of windings, each supported by a respective one of the plurality of winding-carrier segments. Each of the plurality of winding-carrier segments defines a through-hole, and each of the plurality of stator-support segments is received through the through-hole of its corresponding winding-carrier segment.

The presently disclosed subject matter is directed to an electric actuator comprising a housing defining an interior cavity, a stator secured within the interior cavity, the stator comprising a plurality of stator-support segments, a plurality of windings, and a plurality of winding-carrier segments, wherein each of the plurality of winding-carrier segments defines at least one aperture through a sidewall thereof, a rotor rotatably mounted relative to the stator, and a thermally-conductive potting material filling the at least one aperture of each of the plurality of winding-carrier segments to form a direct thermal conduction path between the plurality of windings and the plurality of stator-support segments.

The presently disclosed subject matter is directed to a method for assembling an electric actuator. The method comprises forming a plurality of stator segment sub-assemblies by, for each sub-assembly, providing a stator-support segment, attaching a winding-carrier segment to the stator-support segment, and winding a conductive wire around the winding-carrier segment to form a winding. The method comprises joining the plurality of stator segment sub-assemblies to one another to form an annular stator, heating a housing to cause thermal expansion of an interior cavity of the housing, inserting the annular stator into the expanded interior cavity of the housing, and cooling the housing to cause the housing to contract, thereby securing the annular stator within the housing via an interference fit.

The presently disclosed subject matter is directed to a winding-carrier segment for a stator of an electric motor. The winding-carrier segment comprises an outer cap structure and an inner cap structure, and a main body extending between the outer cap structure and the inner cap structure, the main body configured to receive a winding. The main body, the outer cap structure, and the inner cap structure collectively define a through-hole configured to receive a stator-support segment. The main body defines at least one aperture extending through a sidewall thereof, the at least one aperture configured to be filled with a potting material to create a thermal conduction path between the winding and the stator-support segment when assembled in the stator.

The presently disclosed subject matter is directed to an electric motor stator comprising a plurality of stator-support segments, a plurality of the winding-carrier segments, wherein each of the plurality of winding-carrier segments receives a respective one of the plurality of stator-support segments through its through-hole, a plurality of windings, each wound on a main body of a respective one of the plurality of winding-carrier segments, and a potting material filling the at least one aperture of each of the plurality of winding-carrier segments.

The presently disclosed subject matter is directed to an electric motor comprising a housing defining an interior cavity, and a stator positioned within the interior cavity and comprising a plurality of stator-support segments arranged circumferentially around a central axis, each stator-support segment comprising an outer flange having circumferential side walls with interlocking features, an inner flange spaced radially inward from the outer flange, and a main body extending radially between and interconnecting the outer flange and the inner flange. The interlocking features of adjacent stator-support segments mate to form a self-aligning interface without penetrating fasteners through the segments. The electric motor comprises a rotor positioned concentrically within the stator and configured to rotate about the central axis.

The presently disclosed subject matter is directed to a stator assembly comprising a plurality of stator-support segments arranged circumferentially to form an annular structure, each stator-support segment comprising laminations bonded together without penetrating fasteners, a plurality of winding-carrier segments, each having a main body with sidewalls defining apertures extending between structural members, and thermally-conductive potting material filling the apertures to create thermal conduction paths between electrical windings and the stator-support segments.

The presently disclosed subject matter is directed to a method of manufacturing an electric motor comprising forming a plurality of stator-support segments by stacking and bonding laminations with adhesive, attaching winding-carrier segments to corresponding stator-support segments, winding conductive wire around each winding-carrier segment to form electrical windings, joining the stator-support segments circumferentially to form an annular stator without using penetrating fasteners through the laminations, thermally fitting the annular stator into a housing by heating the housing to expand an interior cavity diameter, and injecting thermally-conductive potting material into voids within the stator after cooling the housing.

The presently disclosed subject matter is directed to an electric actuator for a humanoid robot comprising a motor having a segmented stator with stator-support segments lacking holes therethrough, wherein each stator-support segment includes an outer flange with an axial groove for heat dissipation, a housing having an interior surface in interference fit contact with outer walls of the stator-support segments, and wherein the motor exclusively uses electric actuation without hydraulic, pneumatic, or cable-based actuators.

The presently disclosed subject matter is directed to a winding-carrier segment for an electric motor comprising a main body configured to support electrical windings, an outer cap coupled to a radial outer end of the main body, an inner cap coupled to a radial inner end of the main body, a through hole extending radially through the outer cap, inner cap, and main body for receiving a stator-support segment, and wherein sidewalls of the main body define apertures between corner structural members to allow potting material to create direct thermal paths between windings and the stator-support segment.

The presently disclosed subject matter is directed to a rotor assembly comprising a rotor-support ring extending annularly around a central axis, and a plurality of permanent magnet segments coupled to an outer surface of the rotor-support ring with gaps between adjacent magnet segments. The rotor-support ring comprises multiple concentric laminations bonded by adhesive layers to reduce eddy currents and distribute heat.

In some embodiments, an electric motor's design features a rotor with physically distinct, high-strength neodymium-iron-boron permanent magnets mounted on a support ring. These magnets are arranged in a Halbach array to concentrate the magnetic field towards the stator, and they are separated by gaps that accommodate thermal expansion while reducing eddy current paths. The stator is constructed from an assembly of separate support segments that form an annular ring. Each segment is a stacked layup of 30 to 70 thin laminations, which can be oriented depthwise or radially and may be made of different magnetic materials for the main body versus the flanges. These laminations, which notably lack any holes, are bonded using adhesive or can be pre-coated with a self-bonding insulating layer activated by heat and pressure. To ensure structural integrity, adjacent stator-support segments are joined with complementary interlocking features, such as U-shaped or dovetail protrusions and recesses, and are often secured by laser welding at their outer interfaces.

The electrical windings, which may utilize flat rectangular wire, are wound onto dedicated winding-carrier segments made from Class H insulation material. The surface of these carriers is patterned with grooves or undulations to precisely guide the wire during winding. Each carrier features a main body with a through-hole for a stator-support segment to pass through during assembly, as well as inner and outer caps to shield the end-turns of the winding. Structural protection is provided by L-shaped members at the corners, which also help define apertures that can occupy 40% to 80% of the sidewall surface area, significantly increasing the thermal contact area. Thermal management is further enhanced by embedding oscillating heat pipes in the stator and using phase change materials (PCMs) to absorb transient heat loads. The entire assembly is filled with a thermally-conductive potting material—such as an epoxy, silicone, or polyurethane resin containing filler particles like aluminum oxide or boron nitride—to create an efficient thermal path from the windings.

The manufacturing process may involve securing the stator within a housing via a thermal interference fit. This is achieved by heating the housing to between 100° C. and 300° C., inserting the stator (which has a larger diameter at ambient temperature), and allowing the assembly to cool, creating a precise interference fit. This method leverages the different coefficients of thermal expansion between the housing and the stator materials. After the assembly has cooled, the potting material is injected into all remaining voids. This injection process may be performed under pressure (1-200 psi) or vacuum (0.1-30 torr) to eliminate air pockets and ensure a complete, void-free fill. The resulting motor, with an outer diameter of approximately 68 mm, is capable of producing a momentary peak torque ranging from 15 N-m to 307 N-m.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIG. 2-3A and the corresponding rotational axes of said actuators;

FIG. 4 is a perspective view of one of the actuators of FIG. 3B showing that the actuator includes: (i) a housing, and (ii) a motor positioned within the housing;

FIG. 5 is a front view of the actuator of FIG. 4;

FIG. 6 is an exploded assembly view of the actuator of FIG. 4 and showing an actuator housing and a motor;

FIG. 7 is a perspective view of the motor of FIG. 6, wherein the potting has been omitted to show the stator and the rotor;

FIG. 8 is a front view of the motor of FIG. 6;

FIG. 9 is a cross-sectional view of the motor taken along line 9-9 of FIG. 8, and showing an arrangement of motor windings;

FIG. 10 is a front view of the motor of FIG. 6;

FIG. 11 is a cross-sectional view of the motor taken along line 11-11 of FIG. 10, and showing an arrangement of stator-support segments and the windings;

FIG. 12 is a zoomed in view of an extent of the motor of FIG. 11, and showing an arrangement of round wires in the winding;

FIG. 13 is a top view of the motor from FIG. 6;

FIG. 14 is a cross-sectional view of the motor taken along line 14-14 of FIG. 13, and showing an arrangement of wires in a winding;

FIG. 15 is a diagrammatic representation of a first winding pattern that can be used in the motor of FIGS. 4-14;

FIG. 16 is a diagrammatic representation of a second winding pattern that can be used in the motor of FIGS. 4-14;

FIG. 17 is a diagrammatic representation of a third winding pattern that can be used in the motor of FIGS. 4-14;

FIG. 18A is a front view of a first embodiment of the rotor of FIG. 7, and wherein said rotor includes a layered rotor-support ring;

FIG. 18B is a zoomed-in view of the rotor of FIG. 18A;

FIG. 19A is a front view of a second embodiment of the rotor of FIG. 7, and wherein said rotor includes a layered and segmented rotor-support ring;

FIG. 19B is a zoomed-in view of the rotor of FIG. 19A;

FIG. 20 is a perspective view of the stator of FIG. 7;

FIG. 21 is an exploded assembly view of the stator of FIG. 20, and showing winding, winding-carrier ring, and stator-support ring;

FIG. 22 is a perspective view of the stator support ring of FIG. 21, the stator support ring including a collection of stator-support segments spaced circumferentially apart from one another around a central axis of the motor;

FIG. 23 is a front view of a stator support ring of FIG. 22;

FIG. 24 is a front view of adjacent or neighboring stator-support segments included in the stator support ring of FIG. 23;

FIG. 25 is a perspective view of one of the stator-support segments included in the stator support ring of FIG. 24;

FIG. 26 is an end view of the stator-support segment of FIG. 25;

FIG. 27A is a top view of a first embodiment of the stator-support segment of FIGS. 25-26, and wherein the laminations are stacked in the depthwise direction;

FIG. 27B is a front view of a second embodiment of the stator-support segment of FIGS. 25-26, and wherein the laminations are stacked in a radial arrangement or widthwise about the central axis of the motor;

FIG. 27C is a front view of a third embodiment of the stator-support segment of FIGS. 25-26, and wherein the laminations are stacked in a flat plane arrangement in a direction concentrically outward from the central axis of the motor;

FIG. 27D is a front view of a fourth embodiment of the stator-support segment of FIGS. 25-26, and wherein the laminations are stacked in a curved plane arrangement in a direction concentrically outward from the central axis of the motor;

FIG. 28 is a perspective view of the winding-carrier ring included in the stator of FIG. 21, and wherein the winding-carrier ring includes a collection of winding-carrier segments;

FIG. 29 is a front or end view of a winding-carrier ring of FIG. 28;

FIG. 30 is a perspective view of a winding-carrier segment included in the winding-carrier ring of FIGS. 28-29;

FIG. 31 is a side view of the winding-carrier segment of FIG. 30;

FIG. 32 is a cross-sectional view of the winding-carrier segment taken along line 32-32 of FIG. 31;

FIG. 33 is a zoomed-in view of an extent of the winding-carrier segment of FIG. 32;

FIG. 34 is a front or end view of the winding-carrier segment of FIG. 30;

FIG. 35 is a cross-sectional view of the winding-carrier segment taken along line 35-35 of FIG. 34;

FIG. 36 is a front view of a second embodiment of a motor configured to be inserted in the housing of FIGS. 4-6;

FIG. 37 is a cross-sectional of the second embodiment of the motor taken along line 37-37 of FIG. 36, and showing an arrangement of stator-support segments and the windings;

FIG. 38 is a zoomed in view of an extent of the motor of FIG. 37, and showing an arrangement of flat wires in the winding;

FIG. 39 is a third embodiment of a portion of the motor, wherein the windings have been omitted in order to show the stator-support segments of the stator support ring and an alternative embodiment of the winding-carrier segments of the winding-carrier ring;

FIG. 40 is a front view of the winding-carrier ring included in the motor of FIG. 39;

FIG. 41 is a perspective view of a winding-carrier segment included in the winding-carrier ring of FIGS. 39-40;

FIG. 42 is a side view of the winding-carrier segment of FIG. 41;

FIG. 43 is a front view of the winding-carrier segment of FIG. 41;

FIG. 44 is a flow chart illustrating an assembly process of the actuator of FIG. 4;

FIG. 45 is a block diagram of sensors for the humanoid robot of FIGS. 2-3B; and

FIG. 46 is a block diagram of a communication interface for the humanoid robot of FIGS. 2-3B.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

The advanced actuator disclosed in this application is designed to be a component within a robot system, for example, a versatile and highly-functional humanoid robot. Unlike conventional actuators, the disclosed actuator is designed to possess characteristics such as a small diameter, improved torque density, more efficient thermal management, a modular design facilitating assembly and potential repair, a simplified winding process, reduced overall weight, and quieter operation. These characteristics are beneficial for the actuator's potential use in building robots, including complex systems like general-purpose humanoid robots. To achieve these potential capabilities, the disclosed actuator includes a housing, and a motor. 1 that includes a stator coupled to and located within the housing, and a rotor located within the housing 4 adjacent to the stator for movement induced by the stator. The disclosed stator includes a collection of segment assemblies that are formed separately from one another and are subsequently assembled together to form a complete stator ring structure. Each such segment assembly includes: (i) a stator-support segment, (ii) a winding-carrier segment associated with the stator-support segment, and (iii) a winding that surrounds an extent of both the stator-support segment and the associated winding-carrier segment. This modular construction may facilitate easier manufacturing and potential customization of motor properties.

Unlike certain conventional stator designs, each stator-support segment in this disclosure includes a back iron portion (also referred to as outer flange) having a contoured mating peripheral surface designed to mate with a corresponding complementary mating peripheral surface of an adjacent stator-support segment's back iron. The use of such contoured mating surfaces is beneficial because it may simplify the assembly and magnetic or thermal performance of the stator-support segments. Further, unlike some conventional stators that might use rivets or through-holes for lamination alignment or fastening, each one of the disclosed stator-support segments includes at least one layer, and preferably comprises a collection of layers (laminations), that does not include any through-holes or similar attachment features penetrating the lamination stack within the main magnetic circuit path. Omitting these types of holes or other penetrating attachment features beneficially removes potential conductive pathways for eddy currents, which can improve efficiency and reduce heat generation.

The disclosed rotor may also be constructed in a segmented manner, similar in principle to the stator. The rotor includes a collection of permanent magnets spaced circumferentially from one another around the rotor's support structure. Employing segmented magnets can reduce eddy current losses within the magnets themselves and may allow for shaping or configuring the magnet arc for reduced cogging torque during actuator operation.

The disclosed segmented actuator design offers numerous advantages over other actuator types. As one example, it may be easier and more efficient to wind conductive coils onto individual winding-carrier segments before assembly into the full stator. The segmented design may allow for achieving higher slot-fill factors, meaning more conductive material can be packed into the available space, increasing torque density. The segmented approach may also simplify the automation of the winding process, reducing manufacturing time and cost.

Furthermore, the segmented design can provide greater flexibility for customization and modularity in motor production. For example, it may be easier to produce motors with different pole numbers or varying performance characteristics using the segmented design principles of the present disclosure by simply altering the number or configuration of the segments used. The segmented design approach can also provide better material utilization by reducing scrap material generated during the manufacturing of stator and rotor components. Additionally, the segmented structure can allow for improved thermal management; the interfaces between segments may provide pathways, especially when combined with potting material, for better heat dissipation due to the increased effective surface area available for heat transfer compared to a monolithic structure.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

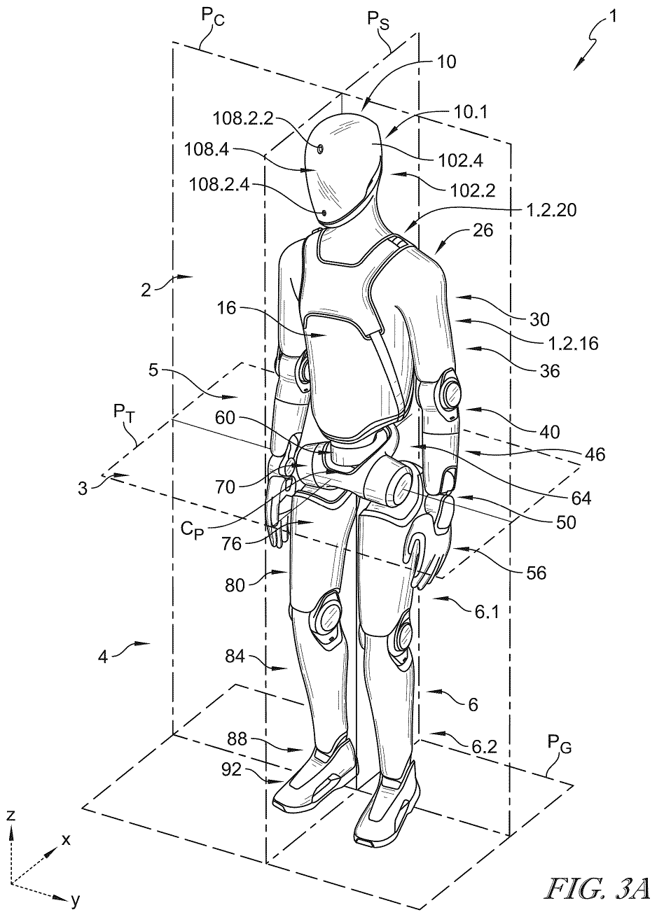

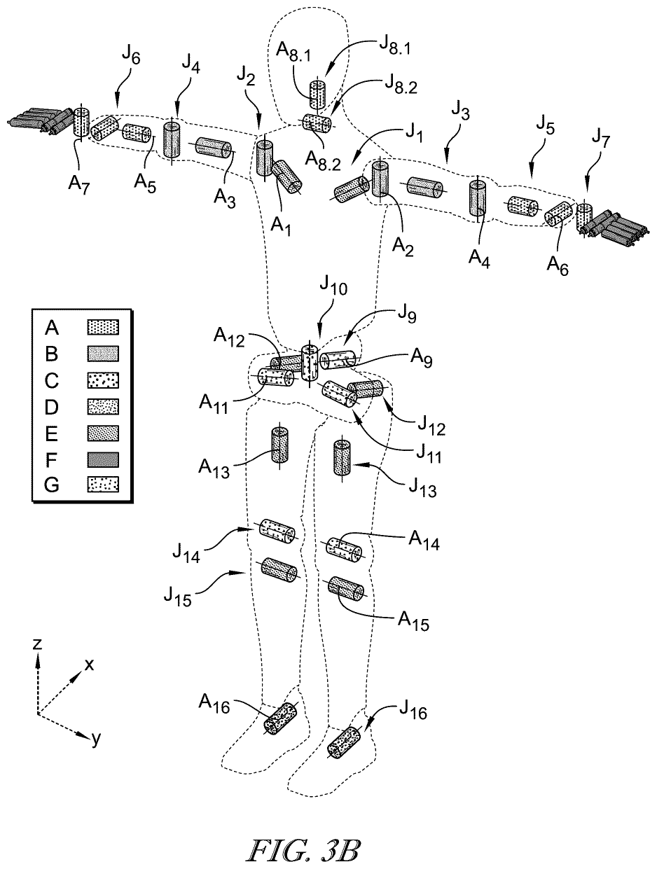

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

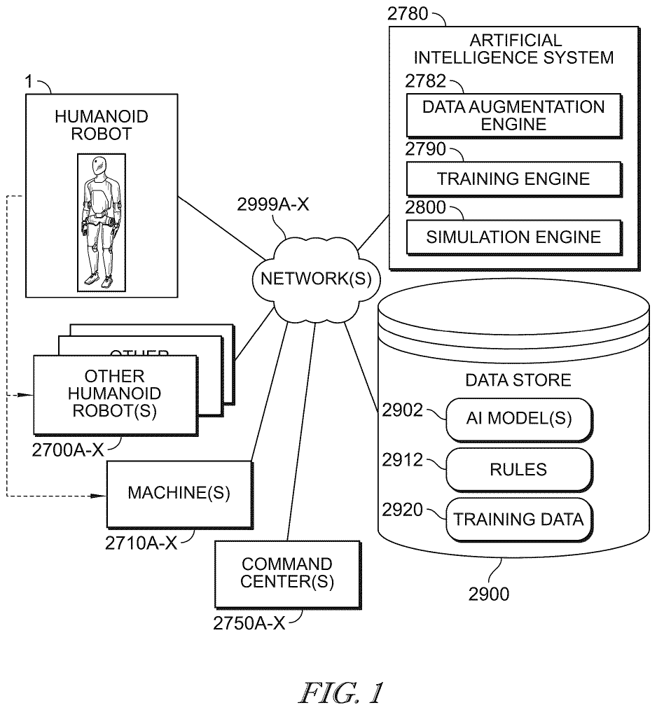

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

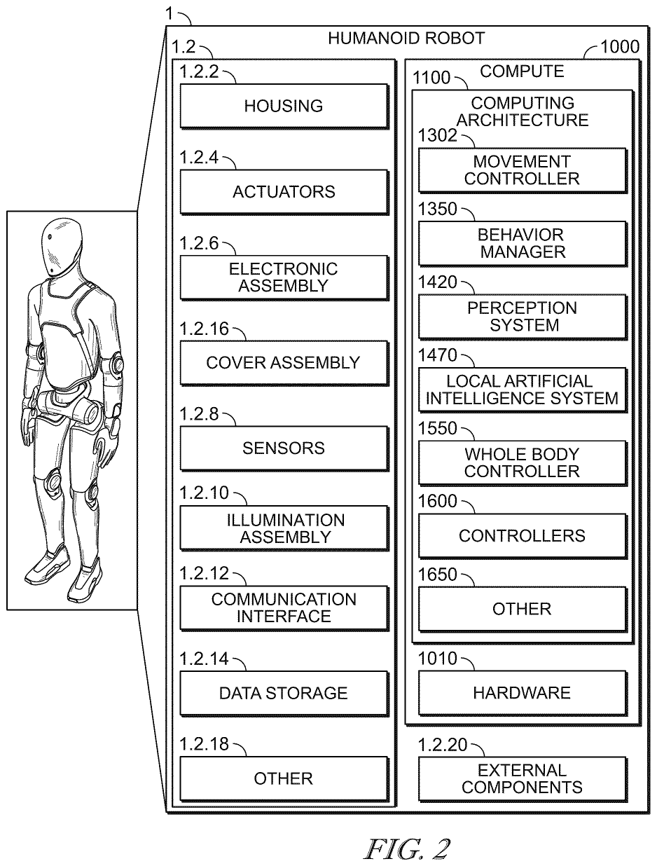

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) may lack the versatility and effectiveness that enable performance of such a diverse array of generalized tasks, particularly in environments designed for bipedal locomotion and anthropomorphic manipulation capabilities.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 1

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, | A₄ |
| | | | lower humerus | |
| (J5) 468 | 2 | lower arm twist | lower arm x, lower arm roll | A₅ |
| (J6) 484 | 2 | wrist flex | wrist/hand y, wrist/hand pitch, flick | A₆ |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, second ankle | A₁₆ |

It should be understood that in other embodiments, some of these systems, assemblies, components, and/or parts may be omitted, combined, or replaced with alternative systems, assemblies, components, and/or parts. The robot 1 only uses electric actuators, and thereby lacks manual, hydraulic, cable-based, or pneumatic actuators. The exclusive use of electric actuators reduces assembly complexity, maintenance requirements, weight, and cost, and increases durability and safety considerations related to operating the robot 1 within or around other humans.

At least 30 of the 42 actuators (12 actuators are included in the hands 56) contained within the robot 1 include: (i) a motor 2.1, (ii) a housing 4, and (iii) thermal management features (e.g., thermally-conductive potting 10, embedded heat sinks, etc.). The motor 2.1 includes at least one component that is configured to rotate relative to the housing 4. The housing 4 surrounds and supports the motor 2.1 and other internal components. Other components that may be included within the actuator 2, such as bearings, torque cells, strain-wave gearbox, associated electrical components, and wiring, may also be housed or supported by the housing 4. The thermally-conductive potting 10 is designed to fill the voids and gaps around the components of the motor 2.1 (e.g., the stator 6) and the housing 4.

### 1. Motor

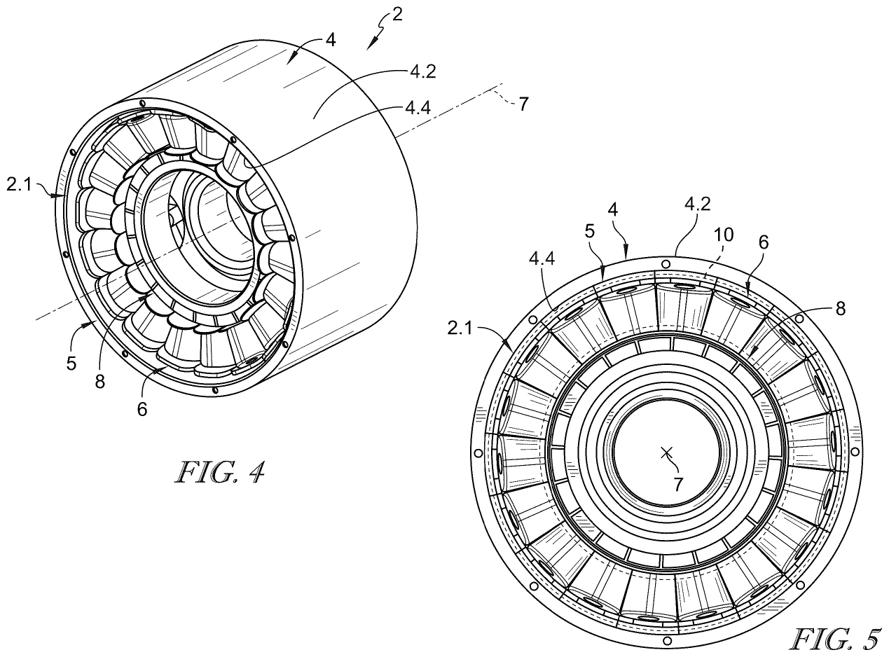

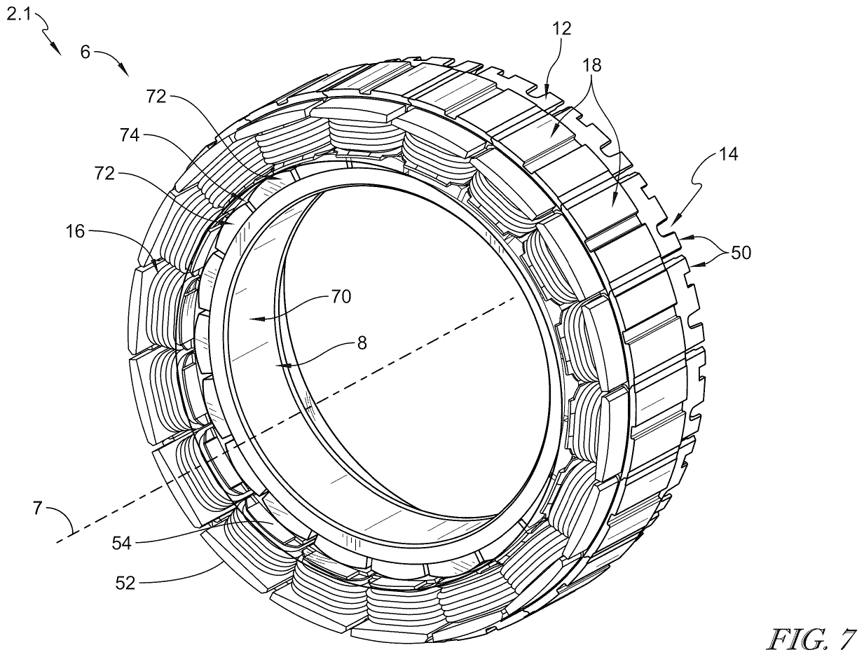

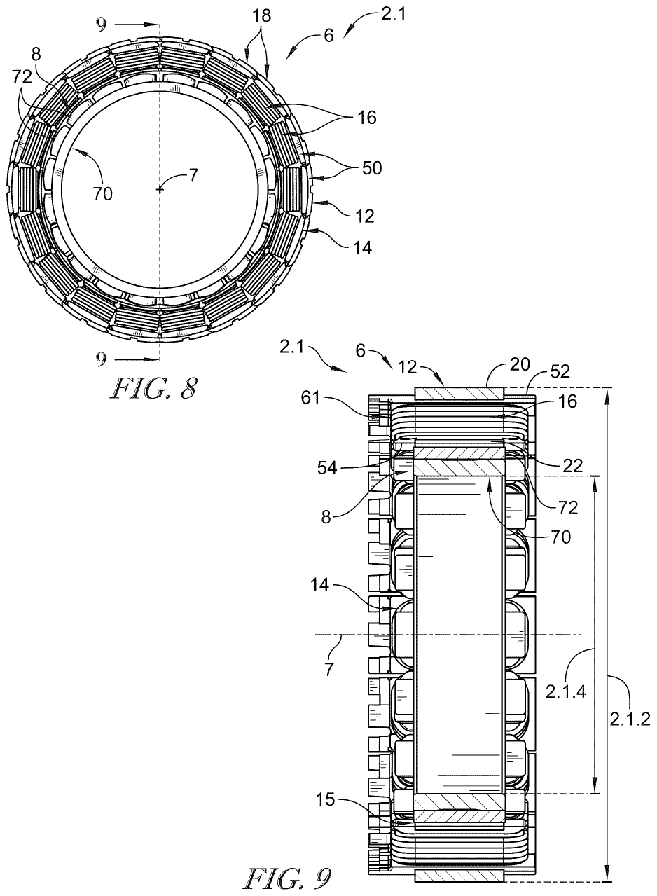

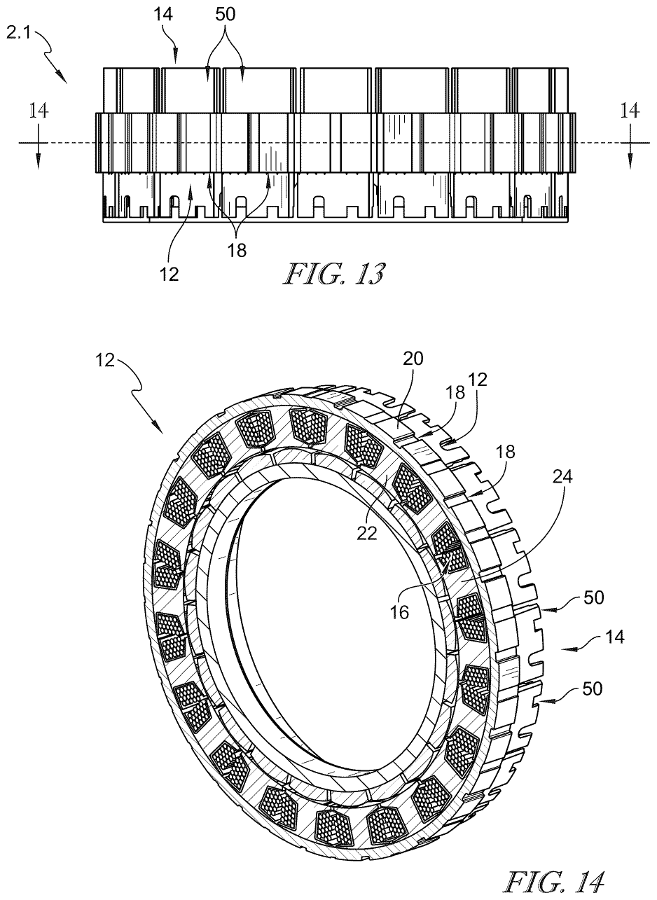

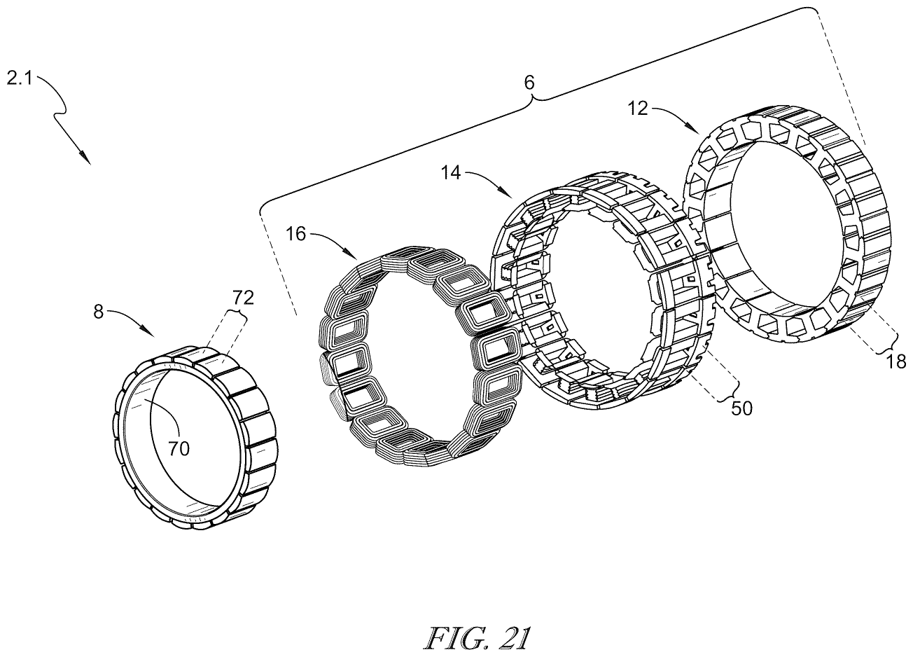

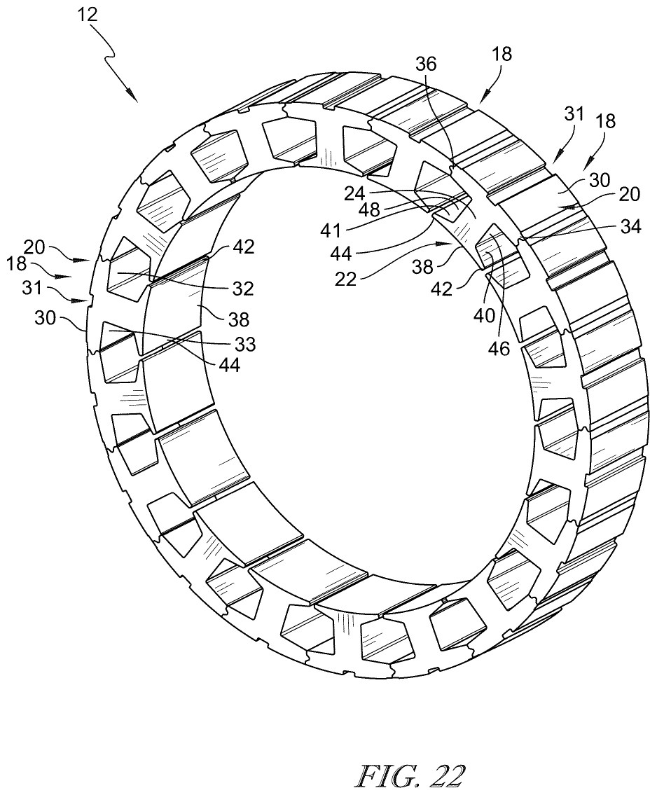

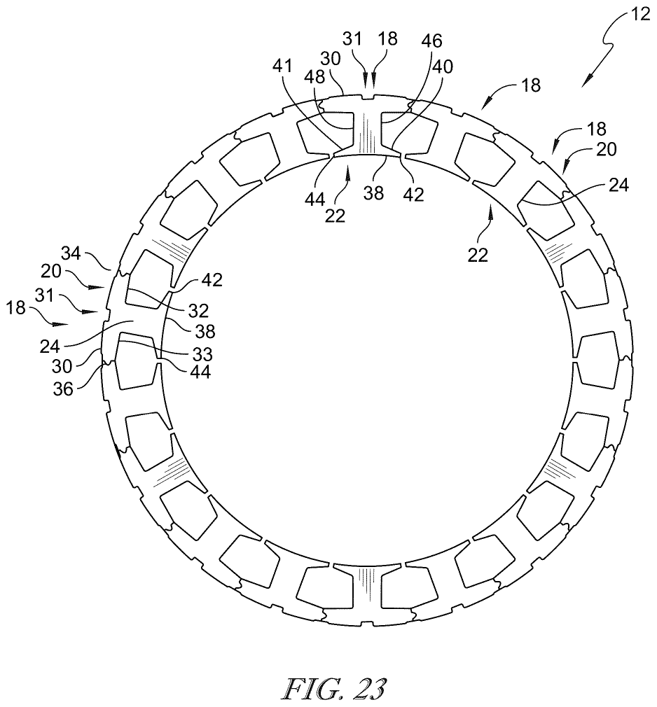

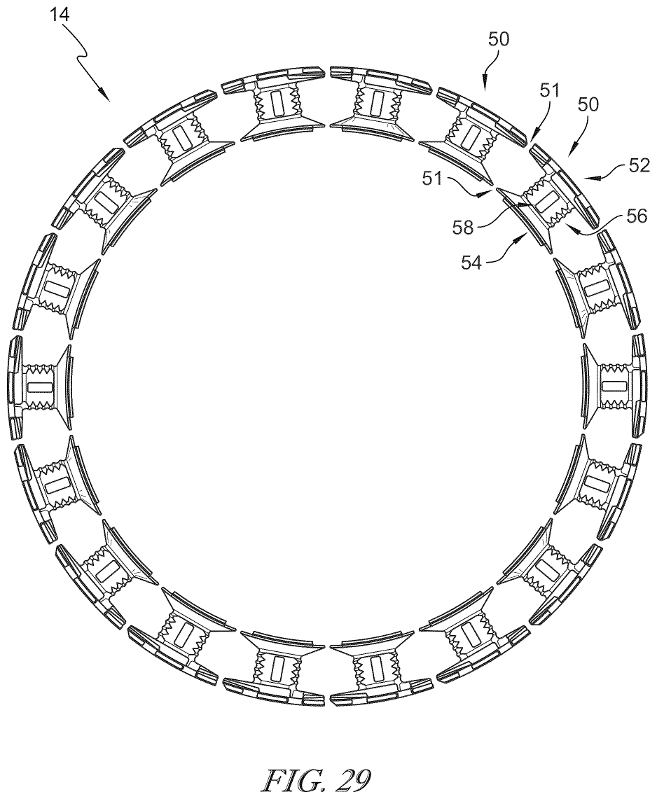

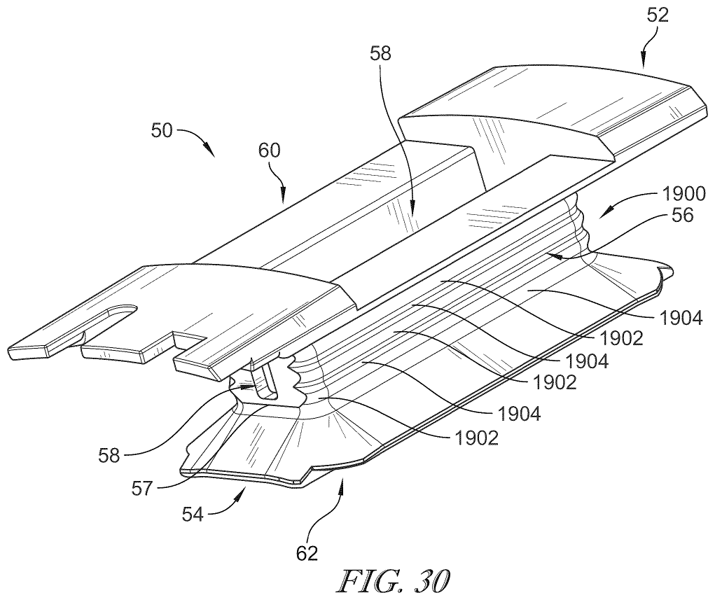

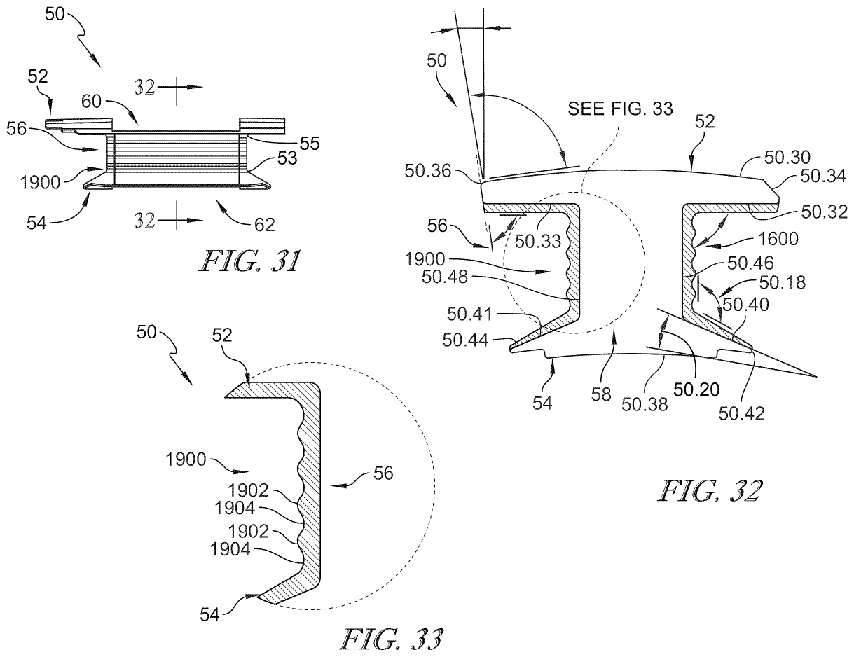

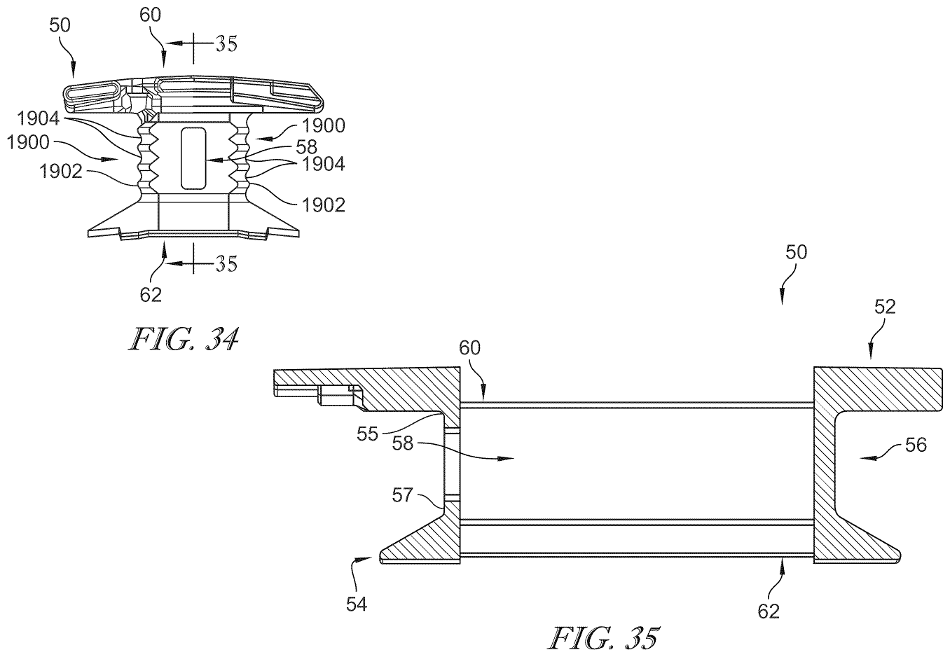

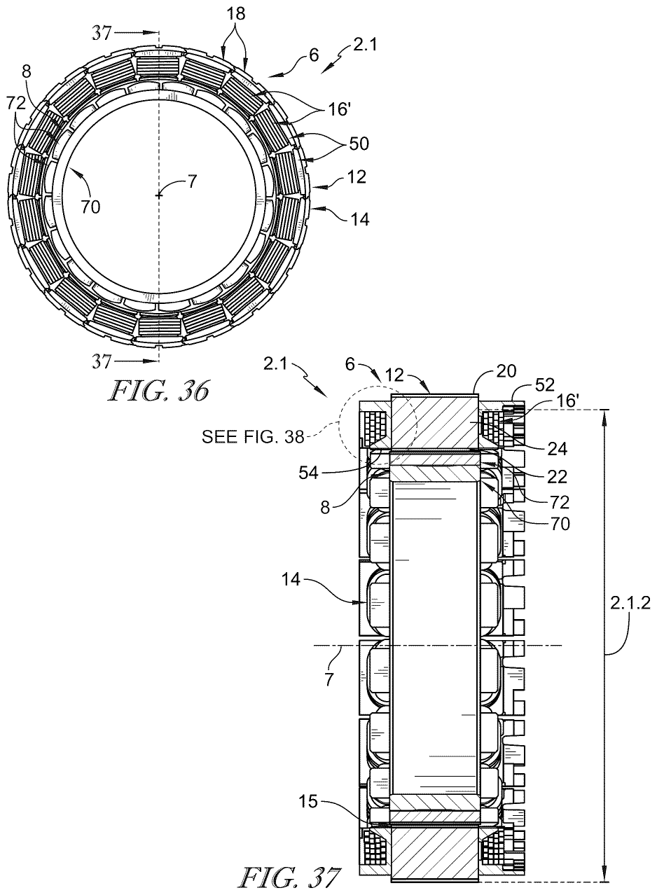

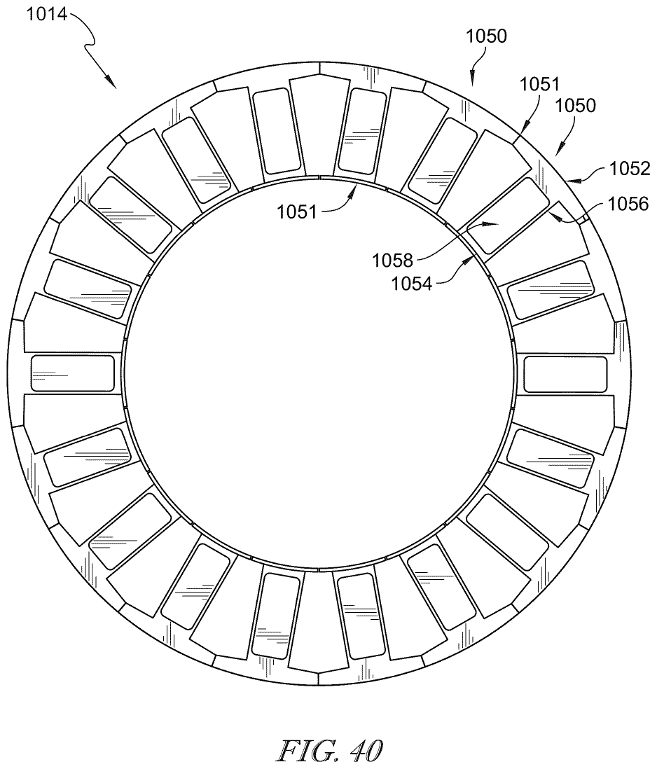

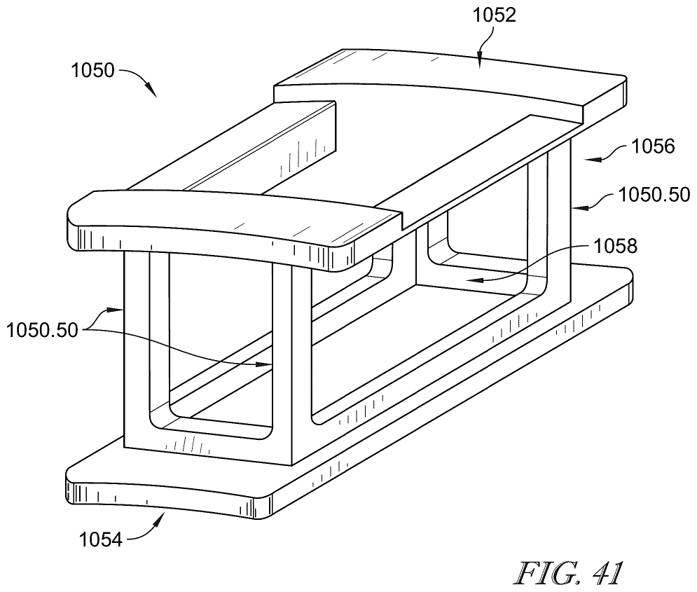

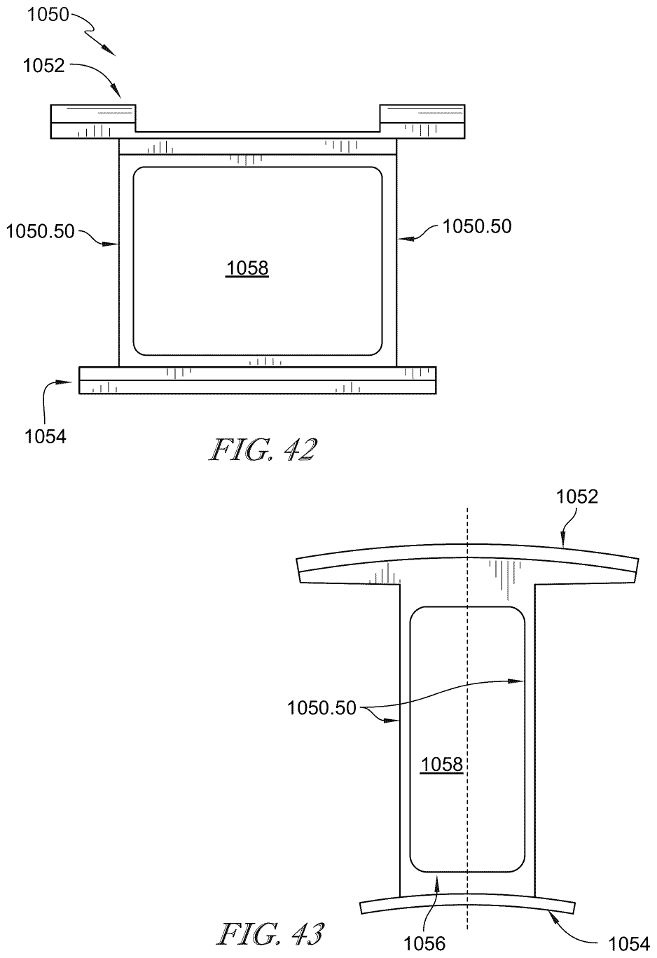

The motor 2.1 of the actuator 2 includes: (i) a stator 6 and (ii) a rotor 8 as shown in FIGS. 4-43. The stator 6 is attached to and housed within an interior cavity 5 of the housing 4. The rotor 8 is mounted rotatably within the interior cavity 5 of the housing 4 and positioned generally inside the annular stator 6, for rotation relative to the stationary housing 4 and stator 6 about a central axis 7. The motor 2.1 may be a brushless DC motor, a synchronous reluctance motor, or a switched reluctance motor, each offering different performance characteristics. The selection of the motor type is guided by the specific application's demands for torque, speed, and efficiency.

a. Stator

As shown in FIGS. 4-14 and 20-35, the stator 6 comprises: (i) a stator-support ring 12, (ii) a winding-carrier ring 14, and (iii) a collection of electrical windings 16. The stator-support ring 12 extends annularly or circumferentially around a central axis 7 of the stator 6 and is formed from a collection of individual stator-support segments 18 joined together. The stator-support segments 18 are composed of a magnetic material, such as laminated steel, which is configured to concentrate and guide the magnetic flux generated by the windings. The winding-carrier ring 14 extends annularly or circumferentially around a central axis 7 of the stator 6 and is formed from a collection of individual winding-carrier segments 50. Each winding-carrier segment 50 is configured to surround at least a portion of a corresponding stator-support segment 18 and is designed to support one or more of the windings 16 relative to the stator-support segment 18 and relative to one another around the central axis 7, while also providing electrical insulation. The winding-carrier segments 50 are made from a non-conductive, thermally stable material to provide electrical isolation between the windings 16 and the stator-support segments 18. The material selection for winding-carrier segments 50 balances dielectric strength, thermal stability, and mechanical properties suitable for the operating environment.

Each of the windings 16 is configured to be energized by an external power source to function as a collection of electromagnets arranged around the central axis 7 of the stator 6. An electronic controller controls the timing and sequence by which the windings 16 (or phases thereof) are energized. This controlled energization causes electromagnetic interaction between the magnetic fields produced by the windings 16 and the magnetic field of permanent magnets 72 included in the rotor 8, resulting in the generation of torque and, consequently, movement (rotation) of the rotor 8 about the central axis 7 relative to the stationary stator 6. The number of windings and their configuration (e.g., number of poles and slots) determines the motor's performance characteristics, such as torque ripple, efficiency, and speed-torque characteristics. The winding configuration also affects the motor's back-EMF waveform, cogging torque, and acoustic noise generation.

i. Stator-Support Ring

The stator-support ring 12 provides the primary structural support for the stator 6 relative to the housing 4 and the rotor 8. The stator-support ring 12 also forms part of the magnetic circuit, acting as a brushless interface between the stationary components of the stator 6 and the rotating components of the rotor 8. The stator-support ring 12 is constructed from a collection of individual stator-support segments 18. The stator-support segments 18 are coupled circumferentially to one another around the central axis 7 of the stator 6 to form the annular stator-support ring 12. The segmented construction facilitates manufacturing, assembly, and winding operations while maintaining magnetic circuit integrity.

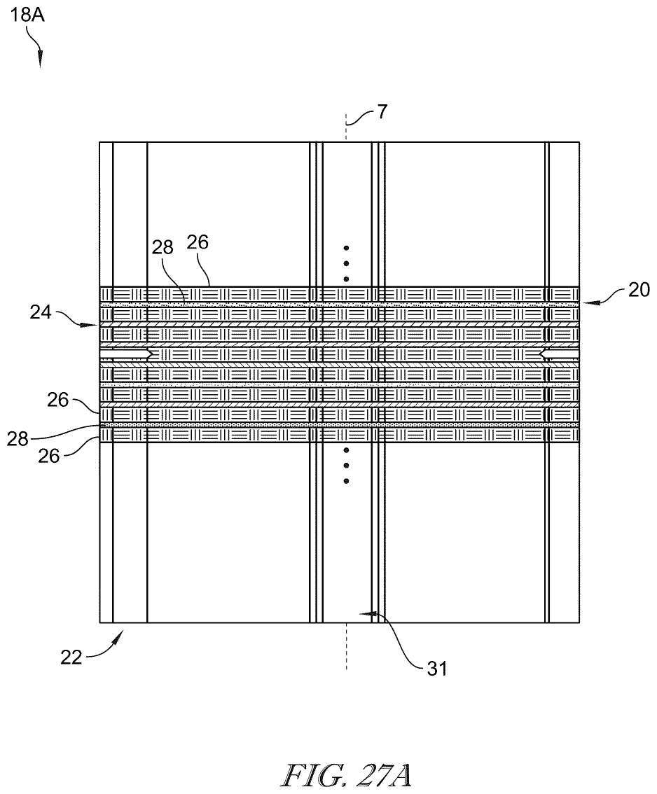

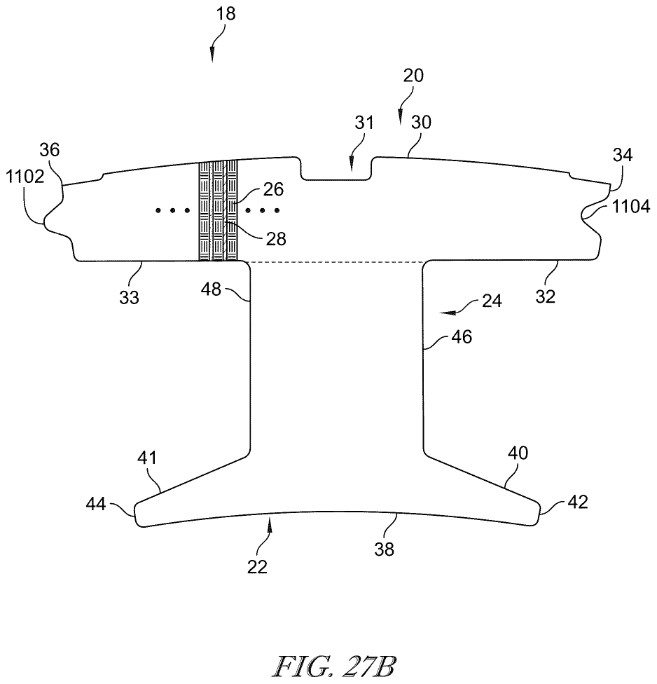

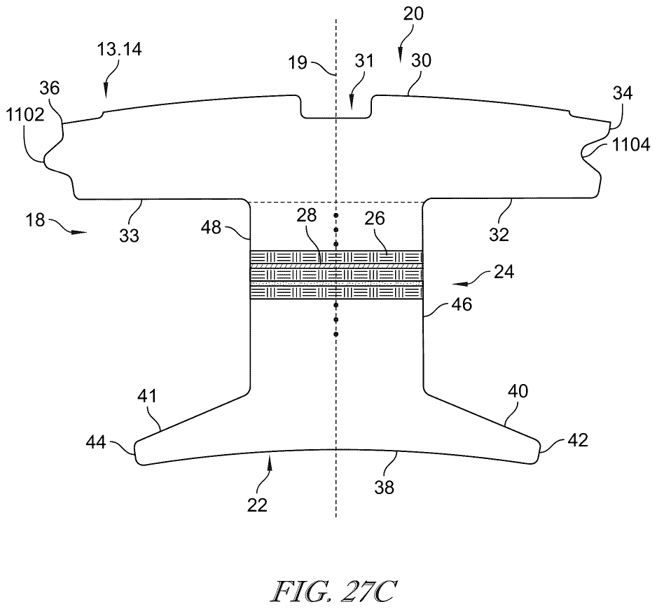

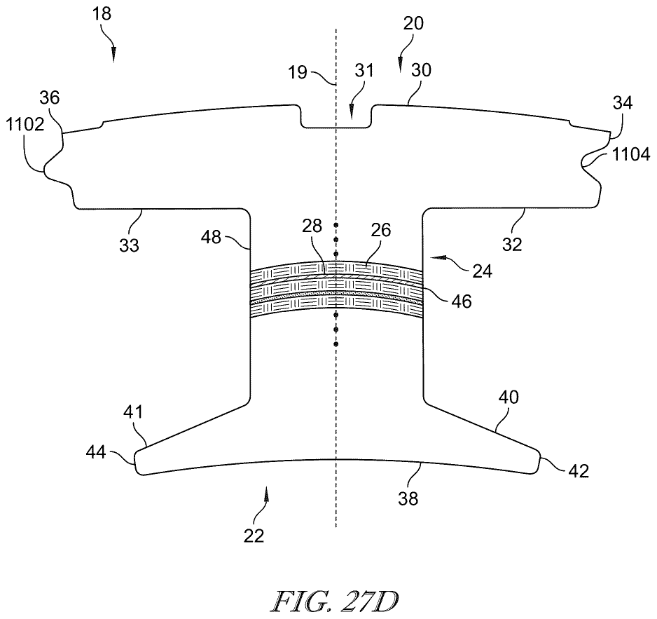

Each individual stator-support segment 18 extends only partway around the central axis 7 and is coupled circumferentially to adjacent segments 18 such that when the collection of stator-support segments 18 are assembled together, the segments 18 form the complete annular stator-support ring 12. As shown in FIG. 27, adjacent segments 18 of the stator-support ring 12 have interlocking features (e.g., protrusions 1102 and recesses 1104) that help facilitate assembly of the stator-support ring 12. The interlocking features provide self-alignment during assembly and maintain precise geometric relationships between segments 18. The adjacent or neighboring segments 18 may then be secured together by welding (laser), brazing, adhesive bonding, mechanical fastening, any other suitable means, or combination(s) thereof. The joining method selection considers thermal stability, magnetic flux continuity, and structural integrity requirements.

In the illustrative embodiment, the complete stator 6 comprises between 2 and 50 individual stator-support segments 18. In some specific embodiments, the stator 6 may comprise between 14 and 22 stator-support segments 18. In other embodiments, the stator 6 may comprise a different number of individual stator-support segments 18. The segmented design of the stator-support ring 12 offers advantages in manufacturing precision and can simplify the process of winding the electrical coils, as each segment can be wound individually before final assembly. The segmentation also enables optimization of magnetic flux paths and reduction of eddy current losses. Each of the stator-support segments 18 lacks any holes formed therethrough in the illustrative embodiment, maintaining continuous magnetic flux paths and structural integrity.

### 1. Stator-Support Segments

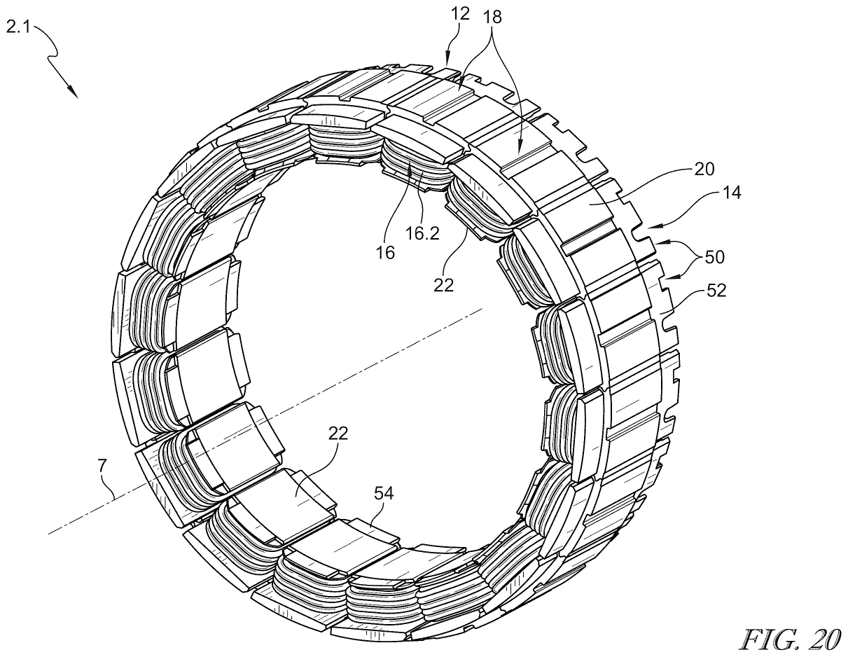

Each of the stator-support segments 18 includes: (i) a back iron or outer flange 20, (ii) a bridge or inner flange 22, and (iii) a tooth or main body 24 as shown in FIGS. 20-27D. The inner flange 22 is spaced radially inward from the outer flange 20 relative to the central axis 7. The main body 24 extends radially between and interconnects the outer flange 20 and the inner flange 22. The outer flange 20 is configured to form a radially outermost extent of the assembled stator 6, providing a surface or wall 30 for attachment or interfacing with the housing 4 (e.g., via the interference fit). The interface between the outer flange 20 and housing 4 provides both mechanical support and thermal conduction pathways. The inner flange 22 is configured to form a radially innermost extent of the stator 6, defining part of an air gap interface 15 between the stator 6 and the rotor 8. The air gap dimension influences motor performance parameters including torque generation, efficiency, and power factor. The tooth or main body 24 extends radially between the inner flange 22 and the outer flange 20 and is positioned circumferentially between two adjacent windings 16 included in the collection of windings 16 when the stator 6 is fully assembled. The main body 24 is the primary structure that carries the magnetic flux from the outer flange 20 to the air gap 15. The dimensions of the main body 24, e.g., its width and depth, are selected to optimize the magnetic circuit and prevent magnetic saturation while minimizing core losses.

The outer flange 20 includes: (i) an outer wall 30, (ii) a pair of inner walls 32, 33 positioned on each circumferential side of the main body 24, and (iii) a pair of circumferential side walls 34, 36, as shown in FIGS. 20-27D. The outer wall 30 is curved to follow the circumference defined by the inner diameter or surface 4.4 of the housing 4. The curvature ensures uniform contact pressure and heat transfer across the interface. The outer wall 30 of the outer flange 20 defines an axial groove 31 that extends axially along the outer wall 30. In some embodiments, the groove 31 may be provided to reduce the mass of the stator-support segment 18 (e.g., reducing the overall weight of the robot 1, reducing the amount of mass that other actuators 2 accelerate when the robot 1 is moving, and extending battery life of the robot 1 because less mass is accelerated by the actuators 2). Mass reduction contributes to improved dynamic response and reduced energy consumption during acceleration and deceleration cycles. In some embodiments, the groove 31 may increase the surface area of the outer wall 30, which can promote passive radiation of heat absorbed or generated by the stator-support segment 18. The increased surface area enhances convective and radiative heat transfer mechanisms. The groove 31 may also be designed to accommodate a cooling element, such as a heat pipe or a liquid cooling channel, for active thermal management as discussed below.

As shown in FIGS. 20-27D, the inner walls 32 and 33 of the outer flange 20 are planar and form an approximately 90-degree angle 13.10 with respect to the main body 24. In other embodiments, the inner walls 32, 33 may be angled and form an angle that is greater than or less than 90 degrees with respect to the main body 24. Additionally, the inner walls 32, 33 may be curved or otherwise shaped in alternative embodiments to optimize magnetic flux distribution or accommodate specific winding configurations. Each circumferential side wall 34, 36 of the outer flange 20 is angled with respect to the outer wall 30 (i.e., angle 13.12) and the inner walls 32, 33 (i.e., angle 13.14). As shown in FIGS. 20-27D, the first side wall 34 extends between the outer wall 30 and the inner wall 32 and the second side wall 36 extends between and interconnects the outer wall 30 and the inner wall 33. The side wall 34 is at a first angle 13.12 relative to the outer wall 30 and a second angle 13.14 relative to the inner wall 32. The side wall 36 is at a first angle 13.12 relative to the outer wall 30 and a second angle 13.14 relative to the inner wall 33. These angular relationships ensure proper magnetic flux transfer between adjacent or neighboring segments 18 while maintaining structural integrity.

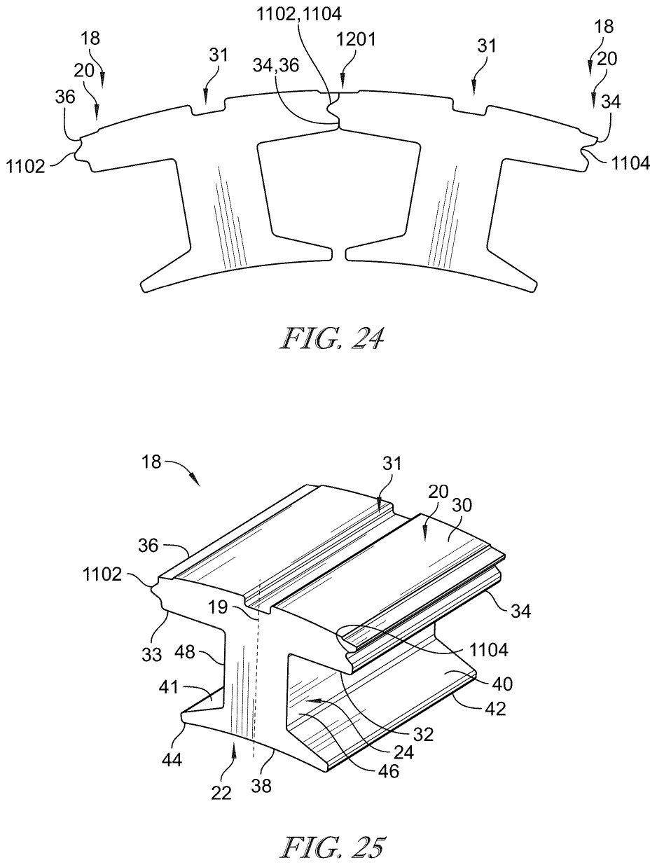

As shown in FIG. 24, the side walls 34, 36 form the interlocking features (e.g., protrusions 1102 and recesses 1104) that mate with the interlocking features on adjacent or + neighboring segments 18. The first circumferential side wall 34 defines a recess 1104 (e.g., functioning as a groove) that extends along the axial length of the outer flange 20. The second circumferential side wall 36 defines a protrusion 1102 (e.g., functioning as a tongue) that extends outward from the general plane of the circumferential side wall 36 and along the axial length of the outer flange 20. The protrusions 1102 and the recesses 1104 are formed to be complementary to each other; for example, each protrusion 1102 is shaped to engage with a recess 1104 on an adjacent segment 18. The complementary geometry ensures precise alignment and minimizes air gaps that could disrupt magnetic flux paths. In some embodiments, the protrusions 1102 and the recesses 1104 may incorporate or be replaced by more complex intermeshing or interlocking forms, such as a tooth and groove design, a shiplap joint design, or a hook and channel design.

The circumferential side walls 34, 36 of the outer flange 20 of each stator-support segment 18 are configured to be joined, for example by welding (e.g., laser welding), to the corresponding side wall of each adjacent or neighboring segment 18 along their interface near the outer interface region 1201 of the outer flange 20. This joining process secures each of the segments 18 firmly to one another to form the rigid stator-support ring 12. The welding process parameters are controlled to minimize heat-affected zones and maintain magnetic properties. The mated protrusions 1102 and recesses 1104 of the circumferential side walls 34, 36 can facilitate this welding process by providing a self-aligning and self-locating feature. These mated or intermeshed side walls 34, 36 may also contribute to reducing magnetic losses and cogging torque produced during the operation of the actuator 2 by providing defined and uninterrupted flux paths across the joint interfaces. The continuous flux paths minimize reluctance variations that could cause torque ripple. In some alternative embodiments, the side walls 34, 36 may be substantially flat or planar and may be free of interlocking features. These substantially planar walls may facilitate this welding process and reduce loss and/or cogging produced during operation of the actuator. Other joining methods, such as adhesive bonding with high-strength structural adhesives, or mechanical clamping using non-magnetic fasteners applied radially or axially outside the main flux path, may be employed instead of or in addition to welding.

Each of the protrusions 1102 may have a rounded or U-shape as shown in FIGS. 20-27D. In other embodiments, each of the protrusions 1102 may have a V-shape, a square shape, a dovetail shape, other suitable tongue-and-groove shape, or combinations thereof. The shape selection influences assembly ease, joint strength, and magnetic flux continuity. Alternatively, the interlocking features may instead be a stepped or stepped scarf joint, a sinusoidal tongue-and-groove joint, or another joint type that self-registers axially and limits weld shrinkage distortion. In some embodiments, the interlocking features of the segments 18 may include micro-keys for enhanced precision alignment.

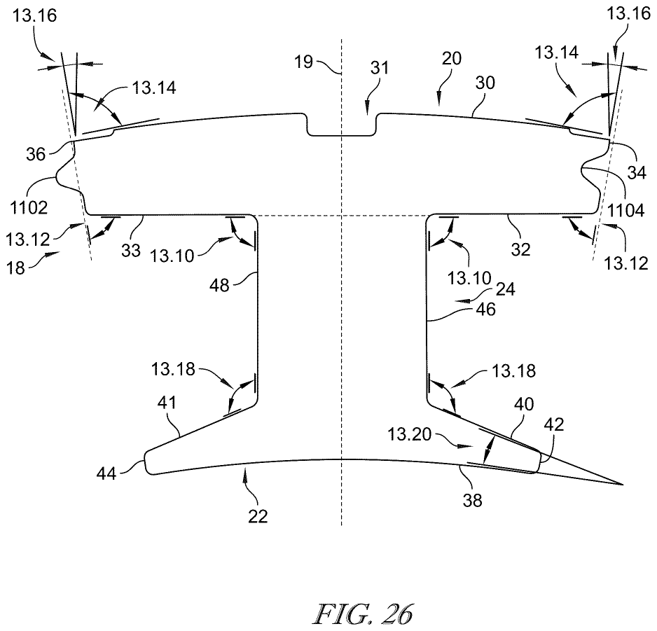

The circumferential side walls 34, 36 are arranged such that the side walls 34, 36 lie along respective radial planes that, if extended, would pass through the central axis 7 as shown in FIG. 26. This geometric arrangement ensures that when the stator 6 is assembled, the protrusions 1102 engage with the recesses 1104 of neighboring segments 18, causing the side walls 34, 36 to lie substantially flush with the neighboring side wall 34, 36 of the adjacent or neighboring stator-support segment 18. In their assembled configuration, adjacent or neighboring stator-support segments 18 form a tongue-and-groove type interface where the protrusions 1102 engage with the corresponding recesses 1104. In some embodiments, this tongue-and-groove configuration involving protrusions 1102 and recesses 1104 may increase the amount of surface area contact between adjacent outer flanges 20, which may enhance structural strength of the assembled stator 6 and may improve thermal transmissivity between adjacent stator-support segments 18. The increased contact area provides additional pathways for heat distribution around the stator circumference. The tongue-and-groove configuration may also improve the manufacturability and assembly precision of the stator 6 (e.g., by providing self-alignment guides during assembly), and may improve the magnetic performance of the stator and thus the actuator 2 (e.g., by improving the alignment of magnetic flux paths crossing between adjacent outer flanges 20).

As shown in FIGS. 20-27D, each side wall 34, 36 of the outer flange 20 is angled relative to a radial line 19 passing through the center of the main body 24. The angle 13.16 of each side wall 34, 36 of the outer flange 20 relative to the radial line 19 is approximately 10 degrees as shown in FIG. 26. This angular value may be more or less (e.g., +/−15 degrees) in other embodiments, depending on electromagnetic design considerations, such as desired flux concentration within the stator 6. The angular orientation affects flux leakage characteristics and magnetic saturation patterns. In some embodiments, each side wall 34, 36 may be arranged at an angle 13.16 relative to the main body 24 within a range of about 5 degrees to about 180 degrees.

The inner flange 22 includes: (i) an inner wall 38, (ii) a pair of outer walls 40, 41 arranged on both circumferential sides of the main body 24, and (iii) a pair of circumferential side walls 42, 44 as shown in FIGS. 20-27D. The inner wall 38 is curved to extend around the central axis 7 and is shaped to interact efficiently with the rotor 8 across the air gap 15, reducing harmonic distortion (e.g., cogging torque). The curvature of the inner wall 38, often referred to as the pole face, can be specifically shaped, e.g., by using a stepped profile or a sine wave profile, to produce a more sinusoidal back-EMF waveform in the windings 16, which can lead to smoother torque output and reduced vibration. The pole face geometry also influences radial magnetic forces and acoustic noise characteristics.

The outer walls 40, 41 of the inner flange 22 extend circumferentially away from the main body 24 and are arranged to extend at an angle 13.18 relative to the main body 24. As shown in FIG. 26, this angle 13.18 is approximately 100 degrees, but this angle 13.18 may be more or less (e.g., +/−25 degrees) in some embodiments. For example, the angle 13.18 may be any value within a range of about 90 degrees (forming a T-shape) to about 135 degrees. This geometry may be selected to provide a secure and stable platform for the windings 16 to be placed around the main body 24. The angular configuration also influences flux leakage patterns and slot fill factor. In some alternative embodiments, the inner flange 22 structure may be omitted entirely, with the main body 24 extending directly to the inner radius facing the rotor 8.

As shown in FIG. 26, the outer walls 40, 41 of the inner flange 22 are arranged to extend at an angle 13.20 relative to the inner wall 38. For example, the inner flange 22 is thickest proximal to the main body 24 and tapers down to a lesser thickness at the circumferential side walls 42, 44. The tapered profile optimizes flux density distribution while minimizing material usage. For example, the angle 13.20 may be any value within a range of about 5 degrees to about 40 degrees. The main body 24 is depicted generally as a rectangular prism in cross-section and has first and second side walls 46, 48 that extend generally linearly (in the radial direction) between the inner walls 32, 33 of the outer flange 20 and the outer walls 40, 41 of the inner flange 22. If the inner flange 22 is omitted, then the main body 24 may further include an inner wall portion that directly interfaces magnetically with the rotor 8 across the air gap 15.

In even further embodiments, the tooth or main body 24 of the stator-support segment 18 may possess alternative cross-sectional configurations other than the generally rectangular shape depicted (e.g., the tooth could be generally round, square, purely circular, triangular, elliptical, or trapezoidal in cross-section) or combinations thereof (e.g., rectangular with significantly rounded edges, or having specifically shaped pole shoes at the inner radial end to optimize flux interaction with the rotor). These alternative cross-sectional tooth shapes might, in some cases, reduce or minimize the need for a separate winding-carrier segment 50, 1050 altogether, allowing windings 16 to be applied directly onto a coated stator-support segment 18 if the shape provides sufficient wire support and insulation may be ensured (e.g., through adequate corner radii and a robust insulating coating).

Alternative tooth geometries affect winding space utilization, flux concentration, and manufacturing complexity. In further embodiments related to the winding carrier function, the insulation and wire support provided by the winding-carrier segments 50, 1050 may be formed using alternative techniques such as applying a thick insulating paint or polymer coating, utilizing 3D printing techniques (additive manufacturing) to create the carrier structure directly on the segment 18 (e.g., using a high-temperature polymer filament or resin), using injection molding as mentioned earlier, or formed in any other known manner that allows for the reliable electrical separation between the stator-support segment 18 and the winding 16. These advanced manufacturing techniques can reduce part count and assembly steps, thereby lowering overall production costs.

### 2. Laminations

Each of the stator-support segments 18 comprises a stacked layup or laminate structure of laminations 26 interleaved with layers of adhesive 28 as shown in FIGS. 20-27D. The stacked layup of the laminations 26 may be stacked in a variety of orientations. For example, the stacked layup of laminations 26 may be stacked (i) in a depthwise direction along the central axis 7 of the motor 2.1, (ii) in a radial arrangement about the central axis 7 of the motor 2.1, (iii) in a flat plane arrangement in a direction concentrically outward from the central axis 7 of the motor 2.1, and (iv) in a curved plane arrangement in a direction concentrically outward from the central axis 7 of the motor 2.1. Each stacking orientation provides distinct electromagnetic and thermal characteristics. In some embodiments, the entire stator-support segment 18 may be layered with laminations 26 and layers of adhesive 28. In other embodiments, only a portion of the stator-support segment 18 may be layered with laminations 26 and layers of adhesive 28. For example, only the main body 24 may be layered, only the inner flange 22 that extends inward from the main body 24 may be layered, only the outer flange 20 that extends outward from the main body 24 may be layered, or some other combination(s) thereof. Layering only specific portions can be used to tailor the magnetic properties or reduce manufacturing cost while maintaining performance specifications.

As shown in FIG. 27A, one or more of the stator-support segments 18 may be formed from a stacked layup of laminations 26 stacked in the depthwise direction, thus, expanding the thickness of the stator, such that each individual lamination 26 includes the profile shape of the outer flange 20, the inner flange 22, and the main body 24, as suggested in FIG. 26. Stacking the laminations 26 depthwise allows each lamination 26 to have an identical shape, thereby making the manufacture of the segments 18 simpler and more cost-effective (e.g., via stamping). The uniform lamination profile also facilitates quality control and reduces tooling requirements.

As shown in FIG. 27B, one or more of the stator-support segments 18B is formed from a stacked layup of laminations 26B stacked in a radial arrangement or widthwise about the central axis 7 of the motor 2.1. The laminations 26B in this embodiment are substantially flat and planar to each other (e.g., defining the inner walls 46, 48 substantially perpendicular to the planes of the sheets 26B). In some examples, layering the laminations 26B in the radial arrangement about the axis 7 may cause the laminations 26B of adjacent stator-support segments 18B to contact each other at the circumferential side walls 34, 36 defined by edges of the laminations 26B, further directing the magnetic flux and/or promoting heat distribution between adjacent stator-support segments 18B.

As shown in FIG. 27C, one or more of the stator-support segments 18C is formed from a stacked layup of laminations 26C stacked in a flat plane arrangement in a direction concentrically outward from the central axis 7 of the motor 2.1. In some examples, layering the laminations 26C in a direction concentrically outward from the central axis 7 may allow the sheets 26C to serve their primary purpose of guiding magnetic flux while also serving as heat transfer structures to conduct thermal energy away from the main body 24 and outward toward the outer wall 30 and/or inward toward the inner wall 38 where it may be radiated or otherwise transported away (e.g., active cooling). The concentric arrangement provides natural thermal gradients that enhance heat dissipation.

As shown in FIG. 27D, one or more of the stator-support segments 18D is formed from a stacked layup of laminations 26D stacked in a curved plane arrangement in a direction concentrically outward from the central axis 7 of the motor 2.1. In the illustrated example of FIG. 32, the curvature of the laminations 26D is exaggerated for ease of understanding and comparison to the other embodiments of the stator-support segment 18, 18B, 18C shown in FIGS. 27A, 27B, and 27C. The curving of the laminations 26D about the axis 7 may cause the laminations 26D of adjacent stator-support segments 18C to contact each other at the circumferential side walls 34, 36 defined by edges of the laminations 26D, further directing the magnetic flux and/or promoting heat distribution between adjacent stator-support segments 18D. The curvature of the laminations 26D may cause the magnetic flux to be guided in a more natural, curved path that may reduce the occurrence of eddy currents and the heat that may be produced by eddy currents. This design may also improve the mechanical strength of the segment 18D by distributing hoop stress more effectively. The curved lamination geometry aligns with natural flux paths, potentially reducing core losses.

The adhesive layers 28 are configured to join each lamination 26 with one another to form the stacked layup of each individual stator-support segment 18 as shown in FIGS. 27A-27D. The adhesive layers 28 increase the insulating properties of the assembled stator-support ring 12 by providing electrical insulation between adjacent laminations 26, thereby blocking the flow of undesired electrical eddy currents within the magnetic core material. The adhesive 28 may also provide structural support to the lamination stack, preventing delamination under dynamic loads and thermal cycling. The adhesive selection considers thermal stability, dielectric strength, and mechanical properties under operating conditions.

Additionally, the stacked layup structure of each stator-support segment 18 allows each segment 18 to maintain its structural integrity for attachment to each adjacent stator-support segment 18 and for secure mounting within the housing 4, without the need for penetrating holes, passages, pins, rods, or other retaining/interlocking structures passing through the lamination stack itself. Such penetrating structures could provide an electrically conductive pathway for eddy currents or could negatively impact the magnetic properties (e.g., increasing core losses) or structural integrity of the stator 6, decreasing the operational life and durability of the stator 6. Thus, the laminations 26 lack holes formed therethrough as shown in FIGS. 20-27D. The absence of holes maintains continuous magnetic paths and eliminates stress concentrations. The laminations 26 may also have textured interfaces (e.g., micro-asperity or knurled faces) to improve the interlock between the laminations 26 and reduce delamination under thermal cycling. The surface texture can increase the bonding area for the adhesive 28, further enhancing the structural integrity of the segment.

The stacked layup for each segment 18 can include any suitable number of laminations 26, for example, between 1 and 300 individual laminations. In one specific example, the stacked layup includes a collection of laminations 26 numbering between 30 laminations and 70 laminations. Each lamination 26 possesses a thickness (in the stacking direction, usually depthwise) within a range of about 0.01 mm to about 1 mm. In one particular example, the lamination thickness is within a range of about 0.1 mm to about 0.3 mm. The thickness selection balances eddy current losses with manufacturing feasibility and mechanical strength. The thickness of each individual lamination 26 making up the stack may vary slightly relative to one another, in accordance with a manufacturing tolerance, which might be around 1-5%.

Additionally or alternatively, the stator-support segment 18 may incorporate a hollow configuration or internal voids, such that the stator-support segment 18 effectively comprises a first external or shell material and a second internal material or simply a void. The stator-support segment 18 may be a hollow configuration for weight reduction or to allow for internal coolant flow if the voids are interconnected and sealed. The laminations 26 may be arranged to create the hollow stator-support segment 18. Internal voids may also accommodate sensors or additional cooling features.

Each lamination 26 of the stacked layup of laminations 26 comprises a metallic or metallic-based material with magnetic properties. The metallic or metallic-based material may be chosen for its magnetic properties (e.g., high permeability, low core loss). For example, each lamination 26 includes electrical steel, often referred to as silicon steel. The electrical steel used may be either grain-oriented or non-oriented electrical steel, depending on the desired magnetic characteristics and directionality. Grain-oriented steel provides superior magnetic properties along the rolling direction, while non-oriented steel offers uniform properties in all directions. In some embodiments utilizing non-oriented electrical steel, the material can include between 0.5% silicon to 3.25% silicon by weight. The silicon content affects electrical resistivity, core losses, and magnetic permeability. In some embodiments, each lamination 26 can alternatively comprise a nickel-iron alloy, such as materials commonly known as Permalloy (e.g., approximately 45% Ni, 55% Fe) and/or Supermalloy (e.g., approximately 79% Ni, 16% Fe, 5% Mo), which offer high permeability. These alloys provide exceptional magnetic properties for specialized applications. In some embodiments, particularly for high flux density applications, each lamination 26 can comprise a cobalt-iron alloy, such as materials known as Permendur (e.g., approximately 49% Co, 49% Fe, 2% V).

In some embodiments, the different sections (e.g., the outer flange 20, the inner flange 22, and/or the main body 24) of the segment 18 may be made from different metallic or metallic-based materials. For example, the back iron (outer flange 20) and the bridge (inner flange 22, if present) may be made from a first magnetic material (e.g., standard Silicon Iron, SiFe, chosen for cost or structural reasons), while the tooth (main body 24) may be made from a second, different magnetic material (e.g., a Cobalt Iron alloy, CoFe, chosen for higher saturation flux density in the tooth region where flux is concentrated). This may be achieved by using different lamination materials in different regions or by joining separately manufactured parts (e.g., using laser welding or brazing to join a CoFe tooth section to a SiFe back iron section). The material variation optimizes performance while managing costs.

In some embodiments, each lamination 26 (or the segment as a whole) may comprise one or more amorphous metals (metallic glasses), known for their low core losses at high frequencies. Amorphous metals provide reduced hysteresis losses and improved efficiency at elevated switching frequencies. In yet other embodiments, each lamination 26 (or the segment) can comprise one or more soft magnetic composites (SMCs), which consist of insulated iron powder particles pressed together, offering isotropic magnetic properties and enabling more complex 3D shapes. SMCs enable three-dimensional flux paths and reduced eddy current losses. It is also contemplated that in some embodiments, one or more of the stator-support segments 18 within a single stator 6 can include a stacked layup comprising laminations 26 made from any combination and arrangement or order of the various materials described above, allowing for optimization of properties in different parts of the magnetic circuit. For instance, a hybrid stack using high-saturation material like CoFe near the tooth tip and lower-loss SiFe in the back iron may be employed.

Each layer of adhesive 28 comprises an electrically insulating adhesive 28. The adhesive 28 applied between each of the laminations 26 can include any suitable bonding agent capable of securely joining the laminations 26 together while providing electrical insulation and withstanding operational temperatures and stresses (e.g., an electrically insulating adhesive). In some embodiments, the adhesive 28 can include: (i) an epoxy resin, available in either one-part (heat-cured) or two-part (chemically cured) formulations, (ii) a silicone-based adhesive, known for flexibility and temperature resistance, (iii) acrylic adhesives, (iv) a polyurethane adhesive, (v) an anaerobic adhesive (curing in the absence of oxygen), and/or any other suitable adhesive materials or combinations thereof. Each adhesive type offers specific advantages in terms of cure time, temperature resistance, and mechanical properties. The adhesive materials described above may be used between the laminations 26 within a single segment 18 or across different segments 18. For instance, more than one type of adhesive material may be used in the stacked layup between different sets of laminations 26, especially when laminations 26 having different core materials are used within the same stack, depending on the chemical compatibility between the material used for each individual lamination 26 and the material used for each adhesive layer 28. The adhesive 28 may be applied to one or both sides of each lamination 26 prior to stacking, using any suitable method, such as application by brush, spray coating, roller coating, or by vacuum impregnation after stacking. Alternatively, pre-coated laminations, where the insulating and/or bonding layer is applied to the raw lamination material before stamping, may be used to simplify the segment manufacturing process.

Alternative configurations for the stator-support segments 18 are also contemplated below. For example, instead of a laminated structure, some or all segments 18 may be formed from a solid block of soft magnetic composite (SMC) material, allowing for more complex three-dimensional shaping of the segment, including integrated alignment features or cooling channels. SMC construction enables design freedom while maintaining electromagnetic performance. The method of joining adjacent segments 18 could also vary; alternatives to welding include mechanical interlocking features (e.g., dovetail joints) perhaps supplemented with adhesive bonding, or the use of external clamping rings at the inner and/or outer diameters. Furthermore, the segments 18 could incorporate surface coatings, such as insulating oxides or polymers, applied after segment formation but before winding, to provide additional electrical insulation or environmental protection.

ii. Winding-Carrier Ring

The winding-carrier ring 14 is configured to support each of the windings 16 in a precisely spaced relationship relative to the stator-support ring 12 and to provide robust electrical insulation between the conductive windings 16 and the magnetically conductive stator-support ring 12. The winding-carrier ring 14 is formed by assembling a collection of individual winding-carrier segments 50, which are coupled either directly or indirectly to the stator-support ring 12 and arranged around the central axis 7. Similar to the stator-support segments 18, each of the winding-carrier segments 50 extends only partway around the central axis 7 such that when assembled, the collection of winding-carrier segments 50 forms the complete winding-carrier ring 14. In the assembled state, each of the segments 50 may be coupled directly to adjacent segments 50, or some spacing or an air gap 51 may be intentionally provided between adjacent segments 50, for thermal expansion or manufacturing tolerance. The controlled spacing accommodates differential thermal expansion during operation. The material for the winding-carrier ring 14 is selected for its high dielectric strength, thermal stability, and mechanical toughness to withstand the forces exerted by the windings 16 during operation.

In the illustrative embodiment, the complete stator 6 comprises between 2 and 50 individual winding-carrier segments 50. In some specific embodiments, the stator 6 may comprise between 14 and 22 winding-carrier segments 50. In other embodiments, the stator 6 may comprise a different number of individual winding-carrier segments 50. The segment count affects winding complexity and assembly time.

### 1. Winding-Carrier Segments

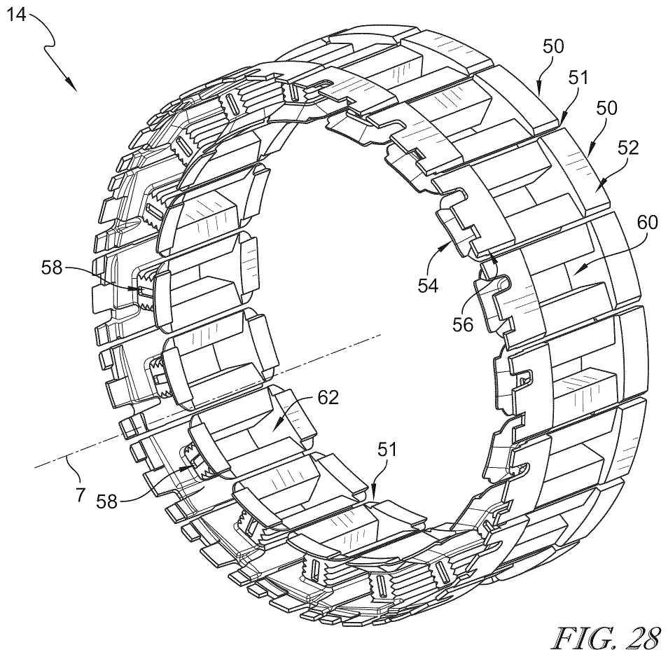

Each of the winding-carrier segments 50 includes: (i) an outer cap structure 52, (ii) an inner cap structure 54 spaced radially inward from the outer cap 52 relative to the central axis 7, and (iii) a main body 56 extending generally axially and/or radially between and interconnecting the outer cap 52 and the inner cap 54 as shown in FIGS. 28-35. The outer cap 52 is coupled to, or formed integrally with, a radial outer end 55 of the main body 56 and is configured to overlie or shield an outer end-turn portion 61 of a respective winding 16. Similarly, the inner cap 54 is coupled to, or formed integrally with, a radial inner end 57 of the main body 56 and is configured to overlie or shield an inner end-turn portion 61 of the respective winding 16. Each winding 16 is wound around the respective main body 56 such that the bulk of the winding 16 is arranged radially between the outer cap 52 and the inner cap 54. This arrangement ensures that the outer and inner caps 52, 54 physically block or shield other portions of the actuator 2 from contacting the energized windings 16. This provides electrical insulation and mechanical protection for the windings. The caps also prevent wire displacement during operation. The main body 56 is generally configured as a spool or bobbin upon which the wire of the winding 16 is wound.

The inner cap 54 includes: (i) an inner wall 50.38, (ii) a pair of outer walls 50.40, 50.41 arranged on both circumferential sides of the main body 56, and (iii) a pair of circumferential side walls 50.42, 50.44 as shown in FIGS. 28-35. The inner wall 50.38 is curved to extend around the central axis 7 and is shaped to interact efficiently with the rotor 8 across the air gap 15, reducing harmonic distortion (e.g., cogging torque). The curvature maintains uniform air gap dimensions. The outer walls 50.40, 50.41 of the inner cap 54 extend circumferentially away from the main body 56 and are arranged to extend at an angle 50.18 relative to the main body 56. As shown in FIG. 35, this angle 50.18 is approximately 100 degrees, but this angle 50.18 may be more or less in some embodiments. For example, the angle 50.18 may be any value within a range of about 90 degrees (forming a T-shape) to about 135 degrees. The angular configuration provides mechanical support for the windings while maintaining electrical clearance. In some alternative embodiments, the inner cap 54 structure may be omitted entirely, with the main body 56 extending directly to the inner radius facing the rotor 8.

As shown in FIG. 35, the outer walls 50.40, 50.41 of the inner cap 54 are arranged to extend at an angle 50.20 relative to the inner wall 50.38. For example, the inner cap 54 is thickest proximal to the main body 56 and tapers down to a lesser thickness at the circumferential side walls 50.42, 50.44. The tapered profile optimizes material usage while maintaining structural integrity. For example, the angle 50.20 may be any value within a range of about 5 degrees to about 40 degrees. The main body 56 is depicted generally as a rectangular prism in cross-section and has first and second side walls 50.46, 50.48 that extend generally linearly (in the radial direction) between the inner walls 50.32, 50.33 of the outer cap 52 and the outer walls 50.40, 50.41 of the inner cap 54. If the inner cap 54 is omitted, then the main body 56 may further include an inner wall portion that directly interfaces magnetically with the rotor 8 across the air gap 15. The dimensions of the main body 56 are selected to accommodate a specific volume of wire for the winding 16, which directly influences the electrical resistance and inductance of the coil. The cross-sectional area affects copper fill factor and thermal dissipation.

Each of the winding-carrier segments 50 is formed to include a through hole 58 as shown in FIGS. 28-35. This hole 58 extends generally radially through each of the outer cap 52, the inner cap 54, and the main body 56. The through hole provides assembly access and alignment features. In the illustrated example, the hole 58 is rectangular, generally centered upon the outer end 55 with a major axis that extends along about 75% of the height of the main body 56 between the outer cap 52 and the inner cap 54, and a minor axis that extends about 20% of the width of the main body 56 between the first and second side walls 50.46, 50.48. The hole dimensions ensure structural integrity while facilitating assembly. The hole 58 may also be considered as extending through the outer end 55 of the main body 56 when viewed in assembly. In some embodiments, the hole 58 may be located elsewhere along the periphery of the main body 56, such as along the first and second side walls 50.46, 50.48. In some embodiments, the hole 58 may have other shapes, such as square, circle, oval, or any other appropriate combination of these and other round or polygonal shapes. In some embodiments, multiple holes 58 may be formed through the main body 56.

A respective stator-support segment 18 is configured to be received into and pass through the corresponding through hole 58 of a corresponding winding-carrier segment 50 during assembly. Once a stator-support segment 18 is received within the through hole 58: (i) the outer cap 52 of the winding-carrier segment 50 is located radially between the outer flange 20 of the stator-support segment 18 and the winding 16, (ii) the inner cap 54 is located radially between the inner flange 22 of the stator-support segment 18 and the winding 16, and (iii) the main body 56 of the winding-carrier segment 50 is located both axially and circumferentially between the main body 24 (tooth) of the stator-support segment 18 and the winding 16, providing insulation along the sides of the tooth. This arrangement ensures complete electrical isolation between windings and magnetic core.

Both the outer cap 52 and the inner cap 54 are formed to include a respective first channel 60 and second channel 62 as shown in FIGS. 28-35. Once the stator-support segment 18 is received in the through hole 58, the outer flange 20 of the stator-support segment 18 is received within or adjacent to the first channel 60, and the inner flange 22 is received within or adjacent to the second channel 62. The channels provide precise positioning and retention. The outer flange 20 has a greater radial thickness compared to the outer cap 52, allowing the outer flange 20 to extend radially beyond the outer cap 52 for proper attachment or interface with the housing 4. The inner flange 22 and the inner cap 54 may have similar radial thicknesses so that a radially inner surface of both the inner flange 22 and the inner cap 54 are substantially flush with one another, forming a smooth cylindrical inner bore for the stator 6. The smooth bore minimizes air gap variations and reduces windage losses. Alternatively, the radial thickness of the inner cap 54 may be less than that of the inner flange 22, allowing the inner flange 22 to extend radially inward beyond the inner cap 54 in some embodiments. In this way, a close-tolerance air gap interface may be established between the rotor 8 and the stator 6 inner bore.

In illustrative embodiments, each of the winding-carrier segments 50 comprises a material capable of providing high electrical insulation, often characterized by a thermal classification such as Class H insulation (indicating suitability for operation up to, e.g., 180 degrees C.). Suitable materials may include silicone elastomers, or combinations of materials such as mica, glass fiber, and/or aramid paper (as a potential asbestos replacement), combined with suitable bonding agents, impregnating substances, or coating substances such as appropriate silicone resins or other high-temperature polymers (e.g., PEEK-polyether ether ketone, LCP-liquid crystal polymer, PEI-polyetherimide). Material selection balances electrical, thermal, and mechanical properties.

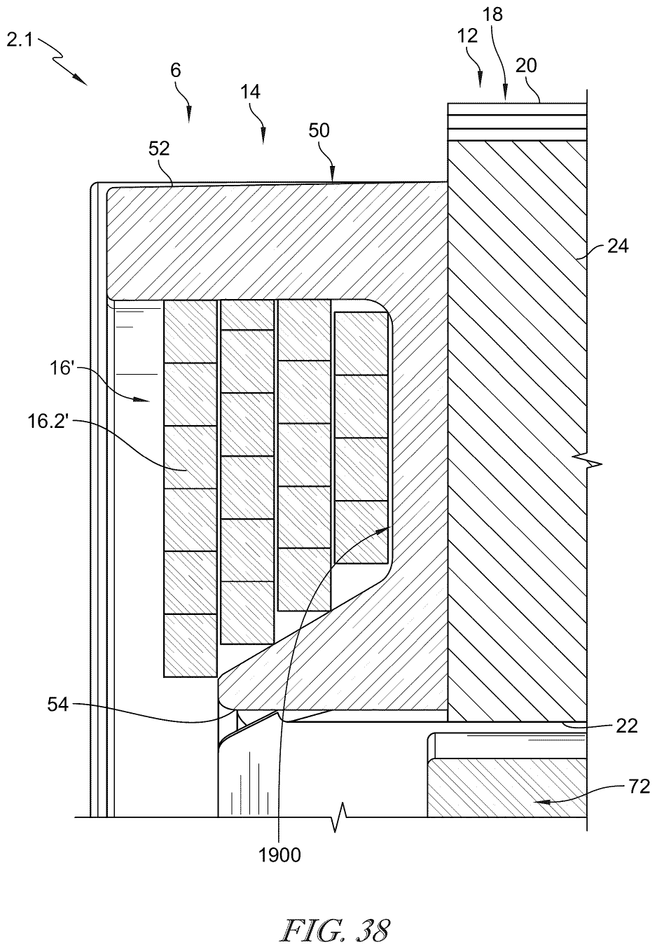

As best visible in FIGS. 28-35, the main body 56 of each of the winding-carrier segments 50 may include patterned surface, e.g., a collection of lateral surface undulations 1900 defined by an alternating pattern of protrusions 1902 and grooves 1904 extending lengthwise along the lateral walls 50.46, 50.48 of the main body 56. The surface pattern guides wire placement and improves winding consistency. In the illustrated example, these surface undulations 1900 are defined with a size and/or shape that is complementary to the dimensions of the wire used for the windings 16. For example, rounded or semi-cylindrical grooves 1904 having a radius of curvature of about 1 mm may be used to complement traditional round magnet wire having a radius of about 1 mm. The groove geometry ensures proper wire positioning and layer transitions. In another embodiment, the grooves 1904 may be formed rectangular or flattened cross-sections to complement flat or rectangular magnet wire like as shown in FIG. 38. For example, the grooves 1904 may be formed with a substantially flat floor between side walls arranged at substantially right angles to the floor. In some examples, the substantially flat floor may be about 1 mm wide between the side walls, and a 1 mm wide flat or rectangular magnet wire may be nested at least partly within the recess 1904. In other examples, the substantially flat floor may be formed to accommodate multiple adjacent loops of wire as a single layer. For example, a substantially flat floor may be about 10 mm wide between the side walls, and ten turns of 1 mm wide flat or rectangular magnet wire may be arranged side-by-side within the recess 1904. The multi-wire grooves enable precise layer control and improved fill factor.

Alternative designs for the winding-carrier segments 50 may involve different materials, such as injection-molded liquid crystal polymers (LCPs) or polyether ether ketone (PEEK) for high temperature stability and mechanical strength. Ceramics, such as alumina or steatite, may also be used for exceptional insulation and thermal stability, perhaps formed by ceramic injection molding or machining. In some embodiments, instead of the grooves 1904, the lateral side walls of the main body 56 may incorporate a collection of small posts or ridges or heddles (e.g., as in a loom) having a predetermined spacing and arrangement, between which the wires of the windings 16 may be placed, intertwined, or interwoven to guide wire placement. In some variations, the winding-carrier segment 50 may be formed not as a separate component but as an insulating coating applied directly to the stator-support segment 18 through processes like powder coating, electrostatic deposition, or conformal coating, simplifying assembly. Furthermore, features like integrated wire terminals or connectors could be molded into the winding-carrier segments 50 to facilitate electrical connection of the windings 16. These integrated connectors could interface with a flexible printed circuit (FPC) or a bus bar system for interconnecting the windings of different segments.

iii. Windings

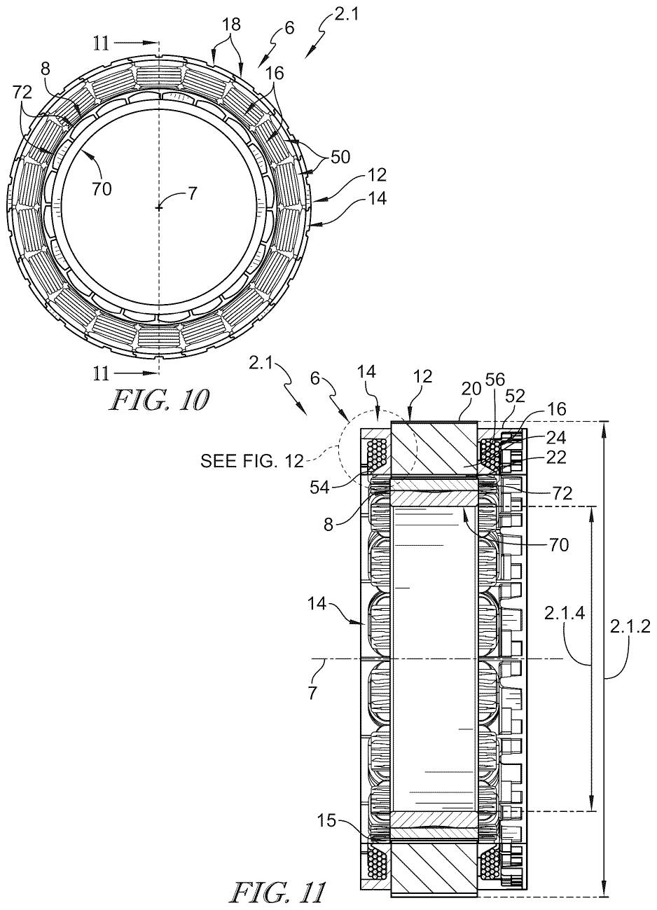

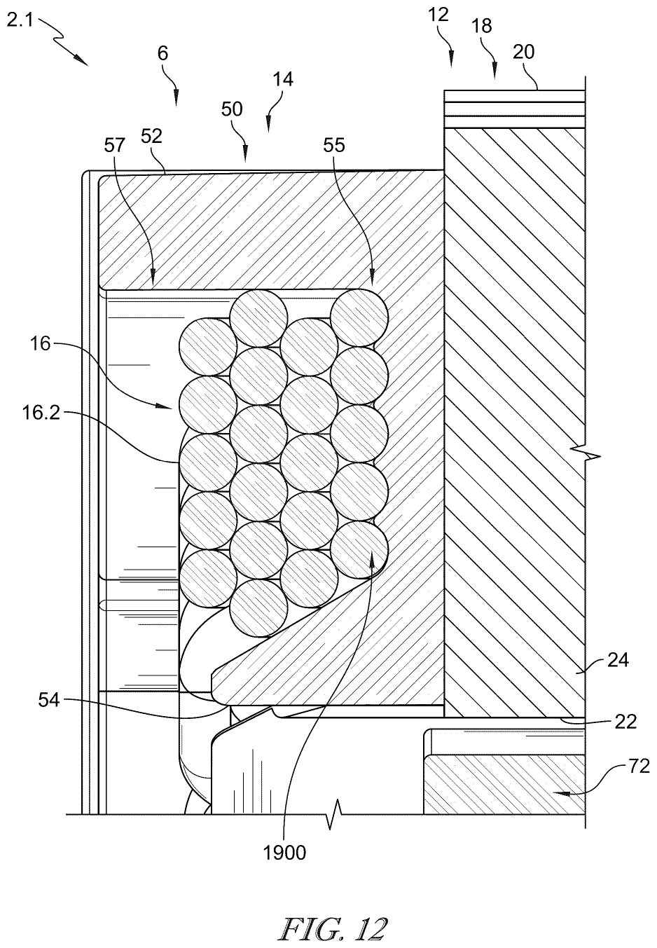

Each of the windings 16 comprises a coil of insulated conductive wire 16.2. As shown in FIGS. 12-17, and 21, the windings 16 are formed from round wire 16.2 wound around the main body 56 of a respective winding-carrier segment 50. As shown in FIGS. 37-38, the windings 16′ may also be formed from flat or rectangular magnet wire 16.2′ wound around the main body 56 of the respective winding-carrier segment 50. The wire geometry selection affects fill factor, heat dissipation, and electrical characteristics. The windings 16, 16′ are designed to be energized by electrical power applied in a precise sequence corresponding to different motor phases. This energization generates a rotating magnetic field within the stator 6 structure, which then interacts with the permanent magnetic field produced by the rotor magnets 72. This electromagnetic interaction results in the generation of torque, causing the rotor 8 to rotate about the central axis 7 relative to the stator 6. The sequence, timing, and magnitude of energizing the different windings 16 (or phases) is controlled by an external electronic controller (motor drive), which adjusts the timing and magnitude of the current supplied to each winding phase to achieve the desired rotational speed, torque output, and position control. This precise electronic control ensures smooth and accurate motor movement. Advanced control algorithms may include field-oriented control, direct torque control, or model predictive control. The winding configuration, including the number of turns, wire gauge, and winding pattern, is designed to achieve the desired torque, speed, and efficiency characteristics of the motor 2.1.

In some embodiments, groups of individual windings 16, 16′, such as adjacent pairs, trios, or other configurations corresponding to a motor phase, may be electrically coupled together (e.g., in series or parallel) to be energized simultaneously as part of that phase. Electrically coupling multiple windings 16 in this manner allows for the generation of stronger magnetic fields for a given current, which can increase the torque output capability of the motor 2.1 and improve its ability to handle higher operational loads. Series connections increase voltage requirements while reducing current, whereas parallel connections increase current requirements while reducing voltage. This approach of using multiple coils per phase can also enhance the efficiency of the motor 2.1 by optimizing the magnetic circuit design, reducing the overall electrical resistance in the circuit, and optimizing the utilization of the available electrical power. The specific configuration and connection scheme (e.g., series vs. parallel) of the coupled windings 16 may be tailored during design to meet specific performance requirements, such as improving or maximizing torque or reducing or minimizing ripple. For example, coupling windings 16 in specific patterns may provide a more balanced distribution of electromagnetic forces around the stator periphery, resulting in smoother rotation and reduced operational vibrations. Balanced force distribution also reduces bearing loads and extends operational life. In contrast, coupling larger groups of windings 16 per phase might be beneficial in applications requiring very high torque output, particularly at lower operational speeds.

The insulation material used for the wire 16.2, 16.2′ of the windings 16, 16′ is configured to withstand the thermal and electrical stresses encountered during motor operation without significant degradation over the desired product lifetime, thereby ensuring long-term reliability and consistent performance. The insulation system may include multiple layers for enhanced protection. The insulation material may be modified polyesters, polyesterimides, polyamideimides, and polyimides, often applied in multiple layers (e.g., base coat and top coat) to meet specific thermal class and mechanical durability requirements. Each insulation type provides specific temperature ratings and dielectric strength characteristics. Additionally, as mentioned earlier, the use of flat wire 16.2′ in constructing the windings 16′, like as shown in FIG. 38, may further improve the performance characteristics, especially when windings 16′ are coupled together. The flat wire 16.2′ has the inherent ability to be tightly packed on the main body 56 (achieving higher slot fill) which allows for more conductor turns per coil within the same volume. This may increase the magnetic flux density generated for a given current, further enhancing the torque output of the motor 2.1. Higher slot fill factors also improve thermal conductivity through the winding structure. A higher slot fill factor also reduces the overall electrical resistance of the winding, leading to lower heat generation and improved efficiency.

Moreover, the specific physical arrangement and pattern of the windings 16, 16′ as they are placed onto the winding carrier main bodies 56 may significantly influence the motor's 2.1 overall magnetic field distribution shape and harmonics. By strategically positioning the windings 16, 16′ and carefully adjusting their electrical coupling and phase relationships, it may be possible to fine-tune various motor characteristics, such as reducing or minimizing undesired cogging torque, improving starting torque characteristics, or achieving a specific desired torque-to-inertia ratio for dynamic performance. Winding distribution also affects back-EMF harmonics and torque ripple characteristics. These types of adjustments optimize the performance of the motor 2.1 within the actuator 2.

The windings 16, 16′ may be wound around each respective main body 56 using any suitable winding technique or pattern, depending on the specific design requirements and the performance characteristics desired for the electric motor 2.1 utilized within the actuator 2. In the illustrated example of FIG. 12, the windings 16, 16′ employ a quadrature winding technique (or similar precisely patterned winding) around each respective main body 56. Quadrature winding, in a broader sense referring to highly structured winding patterns, involves orienting the turns of the windings 16, 16′ in a very specific, often orthogonal or precisely angled manner relative to each other and the slot geometry. Such patterns can create precisely shaped magnetic fields, significantly improving the torque output quality (e.g., reducing torque ripple) and the smoothness of motor 2.1 operation. Precise winding patterns also reduce acoustic noise generation. Certain structured winding techniques, like quadrature winding, can also offer better fault tolerance characteristics, as the independent and well-defined winding sections might allow the motor 2.1 to continue functioning, perhaps at reduced capacity, even if one specific section experiences an electrical failure.

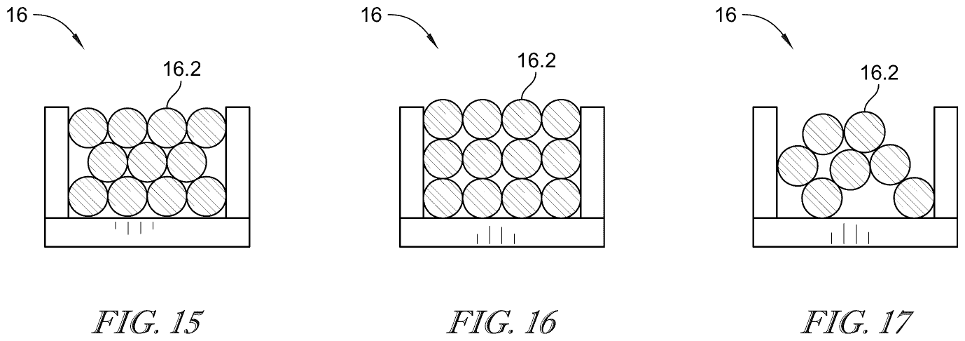

In other embodiments, the windings 16, 16′ may utilize a layered winding approach around each respective main body 56, as shown in FIG. 15. Layered winding involves carefully arranging the wire in organized, generally evenly distributed layers across the width of the winding slot, which ensures a more uniform distribution of current density and the resulting electromagnetic field. Uniform current distribution minimizes hot spots and improves thermal management. The structured layering helps in reducing parasitic effects like eddy currents induced within the windings themselves and generally enhances the overall efficiency of the motor 2.1 by reducing or minimizing electrical and magnetic losses.

In some embodiments, the windings 16, 16′ may be formed using random winding techniques around each respective main body 56, as shown in FIG. 16. This type of winding is often selected for its relative simplicity and lower cost of manufacturing, where the wire is wound in a less precisely controlled, somewhat non-uniform pattern within the available slot area. Random winding may be advantageous in terms of increasing manufacturing speed and possibly reducing material waste compared to more structured techniques. Random winding also requires less sophisticated winding equipment. However, this random winding design may result in slightly higher electrical resistance (due to longer average turn length) and less precise control over the resulting electromagnetic properties compared to other, more organized winding techniques.

As discussed previously in the context of winding-carrier segments 50, each segment 50 may include a collection of lateral surface undulations 1900 that are formed to be complementary to the diameter or shape of the wire 16.2, 16.2′ used for the windings 16, 16′. In some examples, these lateral grooves 1904 may serve to guide and/or align the placement and spacing of the wire 16.2, 16.2′ as it is being wound onto the winding-carrier segments 50. As the wire 16.2, 16.2′ is wound onto the main body 56, the lateral grooves 1904 may help accurately define the position of the first (e.g., innermost) layer of the winding 16, 16′. This guidance may improve the speed, efficiency, and/or accuracy of wire placement, particularly when creating organized, evenly distributed layered windings. Precise wire placement reduces manufacturing variations and improves consistency. In some embodiments, the utilization of such lateral grooves 1904 may promote a more uniform distribution of electromagnetic fields generated by the winding 16, improve the precision of torque control, and also promote more efficient heat dissipation pathways within the assembled windings 16, 16′. By providing a physical guide for organizing the formation of the innermost coils of the wire, a structured layering pattern may be formed more easily and repeatably in subsequent upper layers of the winding, which can help to reduce eddy current losses and enhance the overall efficiency of the motor 2.1 by reducing or minimizing resistive losses.

In some embodiments, the winding 16, 16′ formed on each segment may be shaped such that it increases in thickness (e.g., the number of turns per layer increases, or the layers extend further out) progressing from a radially inner end 57 thereof toward a radial outer end 55 thereof. This progressive increase in winding thickness or extent could serve to concentrate the generated magnetic flux more effectively toward the outer edges of the windings 16, 16′ where interaction with the stator back iron 20 occurs, thereby amplifying the useful magnetic forces produced by the winding 16, 16′. Progressive thickness variation optimizes flux linkage and magnetic circuit utilization. These enhanced magnetic forces can then act more effectively across the air gap on the rotor 8, improving the torque generation capability and overall performance efficiency of the motor 2.1. Additionally, careful design of the winding shape and distribution can promote a more uniform distribution of the magnetic field across the air gap facing the rotor 8, leading to smoother motor 2.1 operation with reduced torque ripple and vibration. This improvement in smoothness can enhance the precision and control of movements generated by the actuator 2.

Furthermore, the specific choice of winding technique implemented—whether it be random, layered, quadrature, or another specialized pattern—may be determined based on a desired balance between manufacturing complexity, associated cost, and the targeted motor 2.1 performance characteristics (e.g., torque density, efficiency, speed range, torque ripple). Additionally, the selection of materials used for the windings 16, such as the type of electrical conductor chosen (e.g., high conductivity copper, or aluminum) and the type and grade of insulation coating applied to the wire, may be selected carefully to significantly affect the motor's 2.1 resulting thermal behavior and electrical characteristics (e.g., resistance, voltage withstand capability). Copper provides superior conductivity while aluminum offers weight advantages.

Alternative winding configurations may include the use of Litz wire, which consists of multiple individually insulated thin strands woven or twisted together, to reduce skin effect and proximity effect losses at higher operating frequencies. Litz wire construction reduces AC resistance at elevated frequencies. For specialized high-performance applications, windings made from superconducting materials could be considered, although this would require significant cryogenic cooling infrastructure. Different winding patterns, such as concentrated windings (where each tooth holds coils from only one phase) versus distributed windings (where coils from a single phase are spread over multiple teeth), offer trade-offs in terms of torque ripple, manufacturability, and fault tolerance. Fractional-slot concentrated windings, where the number of slots per pole per phase is not an integer, may offer benefits in terms of reduced harmonics and shorter end windings. Insulation systems might also vary, including multi-layer insulation, vacuum pressure impregnation (VPI) with varnish instead of potting, or specialized coatings for very high voltage or extreme temperature environments. Methods for securing the windings 16 post-assembly, beyond just potting, could include mechanical banding (e.g., using fiberglass tape) or specialized adhesives applied to the end windings.

In the illustrated example shown in FIG. 38, a winding 16′ is formed from flat (e.g., rectangular cross-section) wire 16.2′. The choice between using round wire 16.2 versus flat wire 16.2′ is often determined by the specific requirements of the motor's 2.1 intended design and application. The round wire 16.2 of the windings 16 is commonly used due to its general ease of handling during winding and often lower manufacturing cost. Round wire also provides flexibility in winding patterns and layer transitions. However, the flat wire 16.2′ of the winding 16′ may offer advantages such as achieving a higher packing density (slot fill factor, meaning less wasted space between conductors) and better thermal performance due to its inherently larger surface area relative to its cross-sectional area, which can facilitate more efficient heat dissipation away from the winding 16′. Flat wire construction also reduces inter-turn voltage stress.

Additionally, as mentioned earlier, the use of flat wire 16.2′ in constructing the windings 16′ may further improve the performance characteristics, especially when windings are coupled together. The flat wire 16.2′ has the inherent ability to be tightly packed on the main body 56 (achieving higher slot fill) which allows for more conductor turns per coil within the same volume. This may increase the magnetic flux density generated for a given current, enhancing the torque output of the motor 2.1 further. The shape and cross-sectional area, e.g., ranging from AWG 30: Approximately 0.0509 mm² to AWG 18: Approximately 0.823 mm², of the chosen wire also directly impacts the electrical resistance and inductance of the resulting winding 16, thereby influencing the overall efficiency, thermal characteristics, and dynamic response time of the motor 2.1. A larger cross-sectional area generally corresponds to lower resistance and thus reduced resistive heating. Wire gauge selection balances current capacity, voltage drop, and space constraints.

b. Rotor

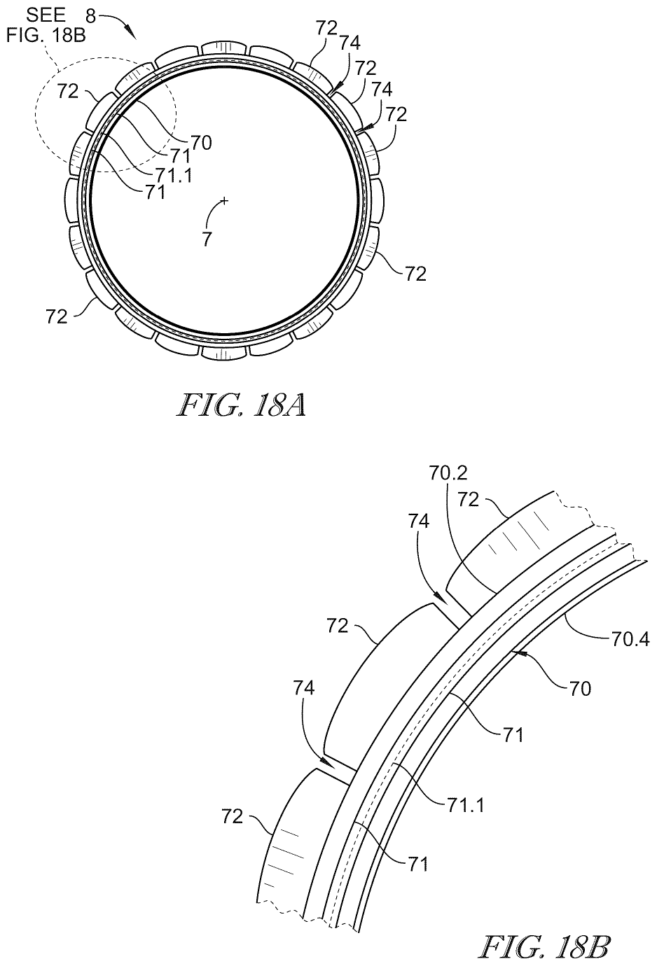

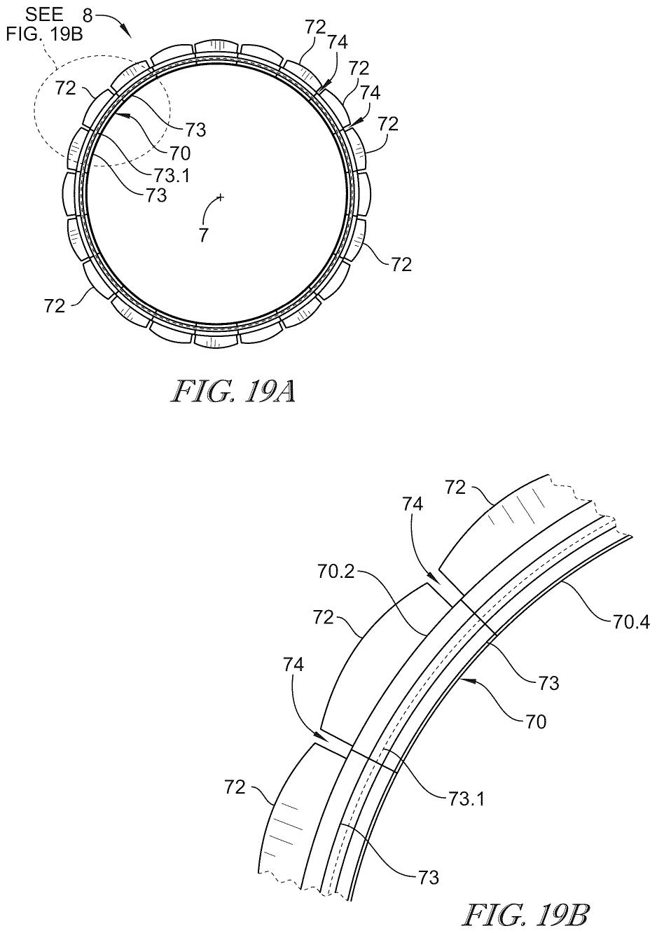

The rotor 8 comprises: (i) a rotor-support ring 70 and (ii) a collection of permanent magnets 72 as shown in FIGS. 18A-19B. The rotor-support ring 70 extends annularly around the central axis 7, providing a structural base for the magnets 72. The ring structure distributes centrifugal loads and maintains magnet positioning. The magnets 72 are coupled to an outer diameter or outer surface 70.2 of the rotor-support ring 70. The rotor-support ring 70 may be coupled either directly or indirectly (e.g., via a shaft, bearings, and gearbox) to an appendage of the robot 1 or may be positioned between two appendages to cause relative movement between them in response to the rotation of the rotor 8 about the central axis 7. The mechanical coupling transmits torque while accommodating misalignment. The collection of magnets 72 are spaced apart from one another circumferentially along the outer surface 70.2 of the rotor-support ring 70, providing gaps 74 between adjacent magnets 72. The gaps accommodate thermal expansion and reduce eddy current paths.

The magnets 72 are configured to interact electromagnetically with the magnetic fields produced by the energized stator windings 16 to cause the desired rotation of the rotor 8. In the illustrative embodiment using permanent magnets, each magnet 72 (or magnetic pole) may be thought of as being pushed or pulled tangentially by the magnetic forces produced by the time-varying magnetic fields from the stator windings 16. The tangential force generation follows the Lorentz force principle. In alternative embodiments, other material that moves predictably in response to a magnetic force may be used, like as in a switched reluctance motor.

In some embodiments, one or more of the permanent magnets 72 used may include materials such as: (i) Neodymium-Iron-Boron (NdFeB); (ii) Samarium-Cobalt (SmCo); (iii) Alnico (Aluminum-Nickel-Cobalt); (iv) various bonded magnets (e.g., Bonded NdFeB or Bonded Ferrite), which are made by bonding fine magnetic powder (such as NdFeB or Ferrite powders) with a polymer binder or epoxy resin; (v) Iron-Chromium-Cobalt (FeCrCo); (vi) Cobalt-Platinum (CoPt) and Iron-Platinum (FePt); (vii) Hexaferrites (Barium Ferrite BaFe, Strontium Ferrite SrFe); (viii) Manganese-Aluminum (MnAl); (ix) any suitable combination thereof; and/or (x) any other similar magnetic material or material formulation that one of ordinary skill in the art may choose to use in constructing magnets 72 for electric motors. Each magnet material offers specific trade-offs between cost, temperature stability, and magnetic properties.

Desirably, the magnets 72 possess both a high residual flux density (Br) and a high intrinsic coercivity (Hcj). A higher Br value generally means the magnet material can produce a stronger intrinsic magnetic field per unit volume. In the context of the electric motor 2.1, this translates to the potential for higher torque generation for a given motor size and current, leading to better power density and improved efficiency. Higher flux density enables more compact motor designs. Utilizing stronger magnets (higher Br) may allow the desired motor performance to be achieved with physically smaller magnets 72, enabling more compact and lightweight overall motor designs. Motors incorporating higher Br magnets can often deliver higher peak power output. Similarly, selecting magnets 72 with higher intrinsic coercivity (Hcj) means the magnets 72 are less likely to become permanently demagnetized when exposed to elevated operating temperatures or strong opposing magnetic fields generated by the stator windings 16. This characteristic ensures reliable operation under demanding conditions. This characteristic is helpful in motors that are expected to operate under high temperatures or within environments subject to fluctuating thermal conditions. Temperature stability extends operational envelope and reliability. High Hcj magnets may better maintain their designed magnetization strength even when subjected to mechanical stress or shock, or upon exposure to strong external magnetic fields. Consequently, motors utilizing high Hcj magnets can exhibit a longer reliable operational lifespan, as the permanent magnets 72 are less prone to degradation or demagnetization over time and use cycles.

As shown in FIGS. 18A-19B, the rotor 8 is effectively segmented in that each of the individual magnets 72 are physically distinct and spaced circumferentially from one another around the rotor-support ring 70. Such segmented magnets 72 may exhibit better cooling characteristics compared to a single continuous magnet ring. The segmentation creates natural convection paths for enhanced cooling. The physical segmentation allows for better airflow or coolant access around the magnets and can facilitate heat dissipation from the magnets 72, reducing the overall operating temperature and thereby increasing the efficiency and operational lifespan of the rotor components. In electrical machines generally, using segmented magnets (and a rotor-support ring 70) can help significantly reduce the generation of unwanted eddy currents within the rotor components. While permanent magnets themselves are often poor conductors, segmentation still helps reduce losses compared to hypothetical solid conductive magnets and allows optimization of the magnet shape (arc length) to reduce cogging torque. Optimized arc length minimizes torque pulsations.

The rotor-support ring 70 may be constructed in a monolithic ring or in a segmented/laminated manner. In the illustrated example of FIG. 18A, the rotor-support ring 70 has multiple concentric laminations 71 that are laminated and bonded by adhesive layers 71.1. The laminated construction reduces eddy current losses in the support structure. In some examples, the laminations 71 may be heat-conductive, and layering the laminations 71 may allow the laminations 71 to promote the distribution of heat (e.g., generated by eddy currents) about the rotor-support ring 70. In some examples, concentric layering of the laminations 71 can increase the strength of the rotor-support ring 70, providing enhanced resistance to centrifugal forces at high rotational speeds. The laminated structure also provides fatigue resistance under cyclic loading.

FIG. 19A shows a second embodiment of the rotor-support ring 70 having multiple segments 73 bonded by adhesive layers 73.1. In some examples, the segments 73 may be affixed to each other by welding, brazing, adhesive bonding, interlocking features, mechanical fastening, any other suitable means, or combination(s) thereof to form the rotor-support ring 70. For example, the segments 73 may have interlocking physical or mechanical features, such as dovetails or a tongue-and-groove configuration. Segmentation of the rotor support ring 70 may be more directly related to reducing eddy currents in the support structure itself. The segmented design also facilitates assembly and maintenance operations.

Individual magnet segments 72 may be produced separately (e.g., sintered and coated) and then assembled onto the rotor-support ring 70. This segmented approach reduces the complexity (for instance, forgoing the need to use a complex post-assembly magnetizer to magnetize a full ring structure) and may reduce the overall cost of production for the rotor assembly. Pre-magnetized segments simplify handling and assembly procedures. Segmentation, particularly of the magnets 72, can also help in managing mechanical stresses. Thermal expansion differences between the magnets 72 and the rotor-support ring 70 may be accommodated more easily with gaps 74 between segments, reducing the likelihood of magnet cracking or failure due to thermo-mechanical fatigue. Stress relief features prevent cumulative damage. Furthermore, if a specific section or single magnet segment 72 of the rotor 8 becomes damaged (e.g., cracked or demagnetized), it may be easier and more cost-effective to replace just that single segment rather than needing to replace the entire rotor assembly. This could lead to lower maintenance costs and reduced system downtime. Modular construction enables field serviceability.

Segmented magnet arrangements also allow for more flexibility in rotor design. Engineers can optimize the rotor performance for specific applications by adjusting the size, shape (e.g., arc length, skewing), spacing (gaps 74), and material grade of the individual magnet segments 72 used. This allows fine-tuning of characteristics like back-EMF waveform, cogging torque, and torque ripple. Design flexibility enables application-specific optimization. Segmented rotors, by virtue of using less magnet material overall or enabling optimization, can sometimes be made lighter than traditional monolithic rotor designs achieving similar performance.

Alternative rotor designs may employ different magnet arrangements, such as a Halbach array configuration, where the orientation of magnetization vectors of adjacent magnets 72 is rotated. Halbach arrays can concentrate the magnetic field on one side (towards the stator 6) while canceling it on the other side (towards the rotor interior), increasing torque density and efficiency. The self-shielding effect reduces rotor back-iron requirements. Different methods for retaining the magnets 72 on the rotor-support ring 70 may be used, such as employing a high-strength non-magnetic retaining sleeve (e.g., made of carbon fiber, fiberglass, Inconel, or titanium) wrapped around the outer diameter of the magnets, using adhesives with high shear strength and appropriate temperature rating, or designing mechanical interlocking features (e.g., dovetails or slots) between the magnets 72 and the rotor-support ring 70. Retention methods balance strength, weight, and thermal considerations. The rotor-support ring 70 itself could be made from different materials, such as high-strength steel, titanium for weight reduction, and a non-magnetic stainless steel. Material selection affects magnetic circuit design and structural integrity. The rotor may also incorporate features for balancing. Dynamic balancing ensures smooth operation at high speeds. Integrated position sensing features, like optical encoder tracks, magnetic encoder rings, or resolver components, may also be incorporated directly onto the rotor 8 assembly or an associated shaft.

### 2. Housing

The housing 4 is designed to provide structural rigidity for the actuator 2, protect the sensitive internal components of the motor 2.1 (e.g., the stator 6 and the rotor 8) from the external environment, and may incorporate features specifically designed to help disperse heat generated by the actuator 2 during operation, especially heat originating from the motor 2.1. The housing serves multiple functions including structural support, environmental protection, and thermal management. An outer diameter or external surface 4.2 of the housing 4 may be positioned within an exoskeleton or structural frame of the robot 1. In other embodiments, the outer diameter or external surface 4.2 of the housing 4 may provide at least a portion of an exterior surface of the humanoid robot 1, blending structural support with external form. The housing integration affects overall robot design and weight distribution. An inner diameter or internal surface 4.4 of the housing 4 defines a housing interior cavity 5, which is dimensioned to house the stator 6 and the rotor 8.

The inner diameter or surface 4.4 of the housing 4 may be manufactured to be slightly smaller than the outer diameter 2.1.2 of the motor 2.1 (e.g., with a diametrical difference between 1 and 1000 microns) at ambient temperature when the motor 2.1 is not installed in the actuator housing 4. This dimensional difference facilitates an interference fit between the housing 4 and the motor 2.1 when the motor 2.1 is installed in the housing 4. The interference fit provides both mechanical retention and thermal coupling. The housing 4 may need to be heated to a specific temperature (e.g., within a range of 100-300 degrees C.) to cause thermal expansion, allowing the motor 2.1 to be placed into the expanded interior cavity 5. Subsequent cooling and contraction of the housing 4 can provide a secure interference fit between the motor 2.1, more specifically the stator 6, and the housing 4, effectively blocking relative movement between these components during operation. The thermal fitting process ensures uniform contact pressure distribution.

In other words, hot dropping the stator 6 of the motor 2.1 into the housing 4 includes placing the housing 4 in an oven or heating the housing 4 to a predefined temperature that is between 50-300° C., preferably between 230-250° C. for a predefined amount of time (e.g., between 5 minutes and 60 minutes, preferably 20 minutes). The heating parameters ensure uniform temperature distribution throughout the housing. The stator 6 is then coupled to a stator insert tool for insertion within the hot housing 4. Once the stator 6 has been inserted within the housing 4, properly aligned in said housing 4, and the housing 4 has cooled to below a predefined temperature, the stator insertion tool may be removed. The controlled cooling process prevents thermal stress and maintains dimensional accuracy. In an embodiment, the actuator housing 4 may be made from aluminum alloy with a coefficient of thermal expansion (“CTE”) of 23.6×10⁻⁶ mm/° C. and the stator 6 may be made from laminated silicon steel with a CTE of 12.0×10⁻⁶ mm/° C. such that the CTE of the stator 6 is less than the CTE of the housing 4. The CTE differential ensures proper interference fit maintenance across operating temperature ranges.

If the housing 4 has an ID of 68 mm and the stator 6 has an outer diameter of 68.085 mm, then when heated the housing ID will expand to 68.353 mm. This will provide a clearance of 0.268 mm and a final interference fit of 0.085 mm at ambient temperature. The dimensional calculations account for material properties and assembly tolerances. However, it should be understood that any interference fit between 0.01 mm to 0.1 mm may be used. In an alternative embodiment, the housing 4 may only be heated to 150 degrees C., while providing 0.124 mm of clearance for an interference fit of 0.085 mm. Further combinations of the interference fit, heating profile, cooling profile, and insertion clearances may be determined based on the above disclosed CTEs, known material CTEs, and/or variables selected by the designer.

In alternative embodiments, the housing 4 may be constructed from materials other than traditional metals. For instance, composite materials, such as carbon fiber reinforced polymers, may be used to reduce weight while maintaining high strength and stiffness. Composite materials also provide design flexibility and vibration damping. Additionally, high-performance engineering plastics with appropriate thermal conductivity and structural properties may be employed. As another alternative, ceramic materials, such as aluminum nitride or silicon carbide, may offer superior thermal conductivity and electrical insulation properties. The selection of the housing material depends on the trade-off between weight, strength, cost, and thermal performance.

The housing 4 may also incorporate integrated cooling features beyond simple passive dissipation. For example, external cooling fins may be positioned adjacent to the housing and/or machined or cast into the housing in order to increase surface area for air cooling. Fin geometry optimization balances heat transfer and weight considerations. Alternatively, internal channels may be formed within the housing walls for the circulation of a liquid or gas coolant. Examples of potential liquid coolants include substances that include water, glycol mixtures, or specialized dielectric fluids. Heat pipes may also be embedded within or attached to the housing 4 to efficiently transfer heat from internal hot spots to external heat sinks or radiating surfaces. Passive heat transfer devices reduce system complexity.

The housing 4 could also be designed with integrated mounting points or interfaces specifically tailored for direct attachment to robot limb structures or other system components, simplifying overall robot assembly. Standardized interfaces enable modular construction. Furthermore, sensors, such as temperature sensors, may be embedded directly into the housing 4 during manufacturing to monitor actuator temperature close to the heat sources. Integrated sensing enables real-time thermal management. Additional sensors, such as vibration sensors or strain gauges, may also be integrated into the housing 4 to provide diagnostic information about the actuator's condition or the loads experienced.

### 3. Thermal Management Features

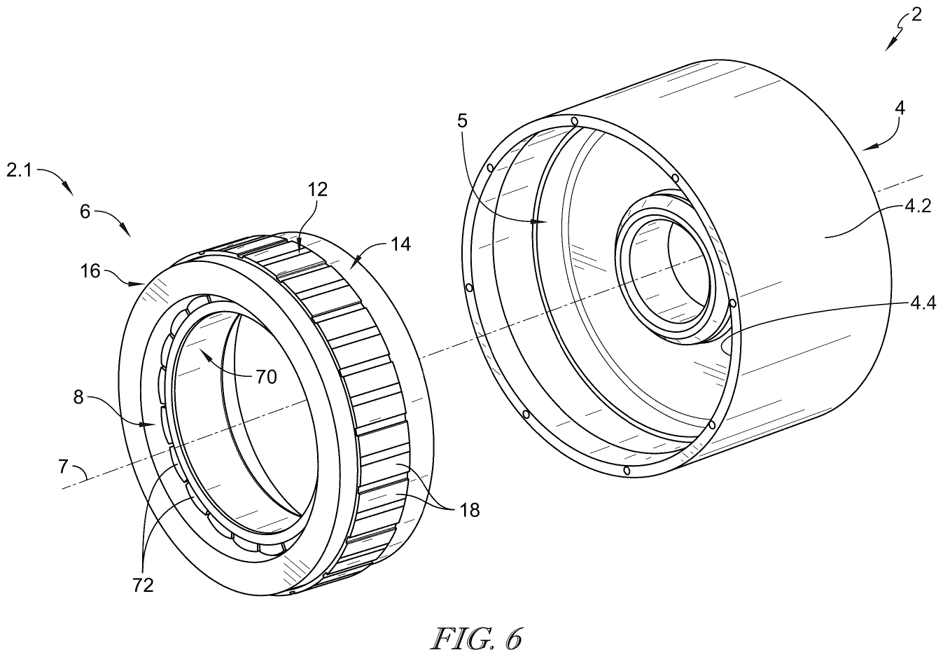

The actuator 2 has thermal management features to cool the motor 2.1. As shown in FIG. 6, the thermal management features include thermally-conductive potting 10 configured to fill a majority of the voids and gaps around the components of the motor 2.1 (e.g., the stator 6) and the housing 4. The potting material serves dual functions of thermal management and structural support. The thermally-conductive potting 10 forms a thermal path between the collection of electrical windings 16 and the plurality of stator-support segments 18 of the stator 6. The thermal path reduces temperature gradients and hot spots. The thermally-conductive potting 10 may be any one of: (i) an epoxy resin with Al₂O₃, BN, AlN, or SiC, (ii) a polyurethane resin, (iii) a silicone resin (often offering flexibility and wider temperature range), (iv) an acrylic resin, or (v) a ceramic-based potting compound for very high thermal conductivity or temperature resistance. Each potting material offers specific thermal conductivity and mechanical properties. In some embodiments thermally-conductive potting 10 specifically includes thermally conductive potting compounds. These are often formed from a combination of: (a) one or more base resin systems like epoxy, silicone, or polyurethane, and (b) thermally conductive but electrically insulating filler particles (e.g., aluminum oxide, boron nitride, alumina nitride, silicon carbide powder). Filler particle size and distribution affect thermal conductivity and viscosity. In further embodiments, the thermally-conductive potting 10 may comprise a hybrid potting compound formulated using a combination of different resin systems (e.g., epoxy-silicone hybrids) in an attempt to leverage the advantageous properties of each constituent resin type (e.g., combining epoxy's rigidity with silicone's flexibility).

The thermal management features may also include: embedded heat sinks (e.g., vapor chambers), liquid-cooling channels, oscillating heat pipes, and other thermal transfer features (e.g., heat transfer fins). Such thermal management features may be formed in the motor 2.1 and/or the housing 4 of the actuator 2. Multiple thermal management strategies provide redundancy and enhanced cooling capacity. For example, the heat transfer features may be formed on: (i) the outer flange 20 of the stator-support segments 18 included in the stator 6, (ii) the inner flange 22 of the stator-support segments 18 included in the stator 6, (iii) the outer cap 52 of the winding-carrier segment 50 included in the stator 6, (iv) the inner cap 54 of the winding-carrier segment 50 included in the stator 6, (v) the outer surface 70.2 of the rotor-support ring 70, (vi) the inner surface 70.4 of the rotor-support ring 70, (vii) within the cavity 5 of the housing 4, and/or (viii) outside of the cavity 5 of the housing 4. The strategic placement of these features is configured to direct heat away from the most thermally sensitive components, such as the magnets 72 and windings 16. Thermal management design considers heat generation patterns and thermal time constants.

### 4. Process of Assembly

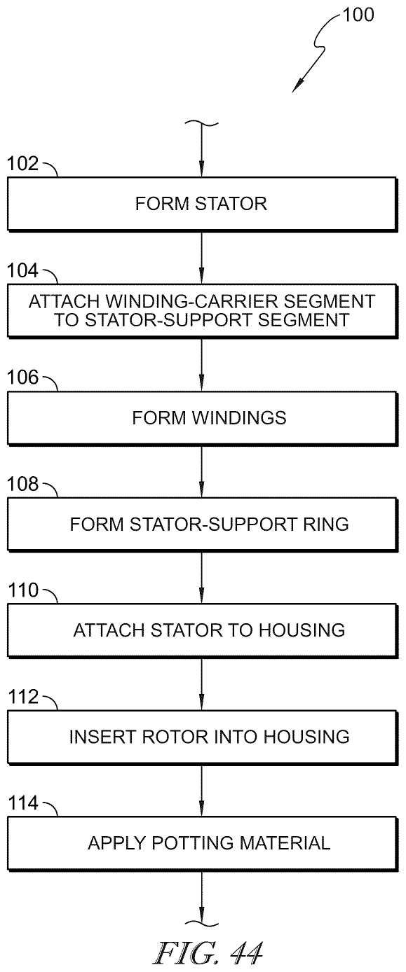

A process 100 for assembling the actuator 2 is outlined schematically in the flow chart of FIG. 44. The process 100 includes a step 102 of forming the stator 6. Forming the stator 6 involves first forming each of the individual stator-support segments 18, from a collection of stamped or laser-cut laminations 26, and layers of adhesive 28. The manufacturing process selection affects production rate and quality. The sheets 26 are stacked in the desired orientation (e.g., axially) and bonded together using the adhesive 28, often under pressure and/or heat, to form a solid laminate blank corresponding to one segment. Process parameters ensure complete bonding and dimensional accuracy. In some manufacturing approaches, the individual sheets 26 in the laminate blank may already be cut to the precise final shape identified for each stator-support segment 18 before stacking and bonding. Alternatively, a simpler shaped laminate blank might be formed first, and then this blank may be machined (e.g., milled or ground) after bonding to achieve the final precise geometry of the stator-support segment 18.

The process 100 further includes a step 104 of attaching each individual winding-carrier segment 50 to its corresponding stator-support segment 18. The stator-support segments 18 may be dimensioned to slide axially into the pre-formed through hole 58 of the winding-carrier segment 50. Assembly tolerances ensure proper fit while maintaining electrical clearance. Alternatively, in another manufacturing approach, the winding-carrier segment 50 material (e.g., a thermoplastic or thermoset polymer) could be formed directly around the stator-support segment 18, for example, using techniques like injection molding or transfer molding, or applied as a coating in another suitable manner.

The process 100 subsequently includes a step 106 of winding the conductive wire around the main body 56 of each winding-carrier segment 50 (which is now associated with its stator-support segment 18) to provide each individual winding 16 thereon, resulting in a collection of wound segment sub-assemblies. Winding tension and pattern control ensure consistent electrical properties. The process 100 then includes a step 108 of attaching each wound stator-support segment sub-assembly to its adjacent neighbors to form the complete annular stator structure. This joining step 108 can involve methods such as welding (e.g., laser welding along the outer diameter interfaces of the outer flanges 20, as mentioned earlier), brazing, adhesive bonding along the mating side walls 34, 36, or using mechanical fasteners or clips if the design incorporates them (though the design aims to avoid penetrating fasteners through laminations). Joint quality verification ensures structural integrity and electrical continuity. Once all the segments 18 (with their associated winding-carriers 50 and windings 16) are securely joined together in the correct circumferential arrangement, the assembly of the stator 6 is substantially complete. The choice of joining method for the segments depends on factors such as thermal stress, magnetic coupling, and manufacturability.

The process 100 further includes a step 110 of attaching the completed stator 6 assembly into the housing 4. As previously described, step 110 can involve heating the housing 4 prior to inserting the stator 6 into the housing interior cavity 5. Temperature uniformity ensures consistent expansion. Heating causes the housing 4 to expand, temporarily widening the housing cavity 5 diameter sufficiently for receipt of the stator 6. In this manner, the stator 6 is effectively “hot dropped” or thermally fitted into the heated housing 4. Upon cooling, the housing 4 contracts, creating a strong interference fit. The controlled cooling rate prevents thermal shock and dimensional distortion. The interference fit provides a robust mechanical connection and an efficient thermal conduction path between the stator 6 and the housing 4. In some alternative embodiments, the stator 6 itself, or a portion thereof, could be cooled (e.g., using liquid nitrogen) to temporarily shrink its outer diameter sufficiently to fit into the housing cavity 5 at ambient temperature, achieving a similar interference fit upon warming.

The process 100 further includes a step 112 of inserting the completed rotor 8 assembly into the housing 4, positioned concentrically within the bore of the assembled stator 6. Appropriate bearings would also be installed at this stage or integrated with the rotor/housing to allow free rotation. Bearing selection considers load capacity, speed, and life requirements. The rotor 8 outer diameter is preferably sized to have a very close tolerance relative to the stator 6 inner diameter, defining a small radial air gap between them, while ensuring sufficient clearance to prevent physical contact during rotation. Air gap uniformity affects motor performance characteristics.

The process 100 may further include a step 114 of packing or injecting a potting material 10 into the stator assembly, after it is mounted in the housing 4, filling the voids around and between the stator windings 16 within the housing 4. The potting process parameters affect void filling and thermal conductivity. Typically, this potting step 114 may be completed or performed within a controlled environment, such as under applied pressure or within a vacuum chamber, to help ensure that the liquid potting material 10 flows and fills most, if not all, of the interstitial voids between the windings 16, winding-carrier segments 50, stator-support segments 18, and the housing 4, reducing or minimizing air pockets which can impede heat transfer or cause electrical issues. Complete void filling maximizes thermal performance and provides vibration dampening.

Alternative assembly procedures may exist. For example, the stator segments 18 could be assembled and joined into the stator-support ring 12 first, followed by inserting or molding the winding-carrier segments 50 onto the ring, and then winding the coils 16 onto the assembled structure (though winding on individual segments is often preferred for slot fill). Process sequence optimization balances quality and efficiency. The order of inserting rotor 8 and stator 6 into the housing 4 might be reversed in some designs, for instance, if the rotor is supported by bearings mounted directly in end caps attached later. Alternatives to thermal fitting (hot drop or cooling) for step 110 could include a precision press-fit at ambient temperature, using mechanical fasteners (e.g., bolts or screws) passing axially through the housing and the stator back iron (if designed to accommodate this without compromising magnetic performance significantly), or using an intermediate sleeve that facilitates the connection, perhaps allowing for easier disassembly. Assembly method selection considers manufacturing capabilities and service requirements. Potting (step 114) could be performed before inserting the stator 6 into the housing 4 in some cases (requiring careful handling), or alternative void-filling techniques like vacuum pressure impregnation (VPI) with varnish could be used instead of or in addition to potting. Automated robotic systems may be employed for consistency and precision in multiple steps, especially winding 106 and segment assembly 108. Quality control steps, such as electrical testing (e.g., resistance, inductance, hipot testing) after winding and after final assembly, and magnetic testing (e.g., back-EMF measurement) would be included in the process.

### 5. Alternative Embodiments

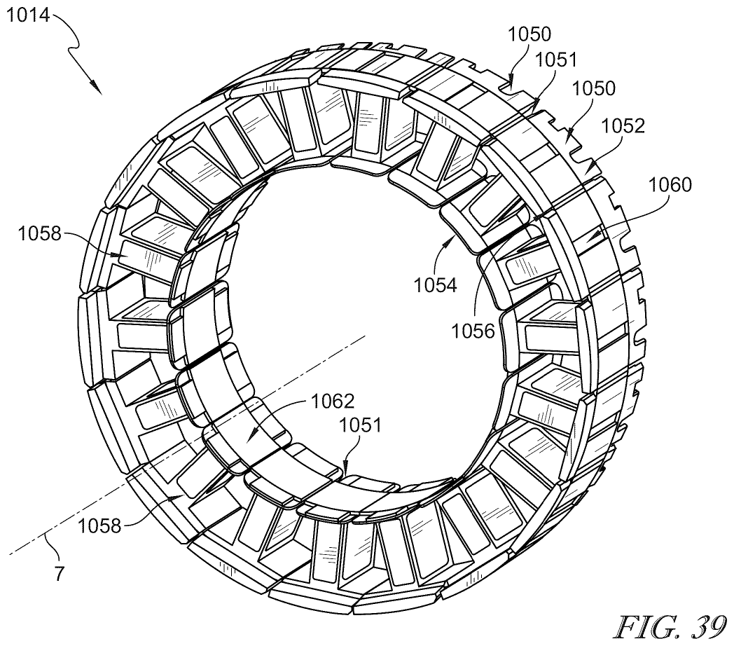

FIGS. 39-43 show an alternative embodiment of winding-carrier segments 1050 for a winding-carrier ring 1014 included in the stator 6 for the motor 2.1. As shown in FIGS. 39-43, the winding-carrier ring 1014 is formed by assembling a collection of individual winding-carrier segments 1050. These segments 1050 are intended to be coupled to the stator-support ring 12 around the central axis 7 of the stator 6, similar to the first embodiment in FIGS. 5-35. In this alternative embodiment, however, a large portion of the material comprising the main body 1056 (compare to main body 56) of the individual winding-carrier segments 1050 has been strategically removed. For example, at least 20%, preferably more than 35%, and most preferably more than 60% (or any percentage therebetween) of the total material from the first embodiment may be removed to form the second embodiment. As such, the opening formed in the segments 1050 may have a length that is at least 2 times longer, preferably 4 times longer, and most preferably 10 times longer (or any value therebetween) than the length of the material that extends from the edge of the side to the side edge of the opening. Additionally, the opening formed in the segments 1050 may have a width that is at least 2 times wider, preferably 4 times wider, and most preferably 10 times wider (or any value therebetween) than the width of the material that extends from the edge of the inner flange to the bottom edge of the opening. Also, The material removal optimizes thermal pathways while maintaining structural integrity.

This removal of material from the main body 1056, effectively creates substantial apertures 1058 within the sidewalls of the main body 1056. In the depicted embodiment, these apertures 1058 extend axially between remaining structural members 1050.50, shown here as generally L-shaped members 1050.50 located at the corners of the main body 1056 sidewalls. The L-shaped geometry provides wire protection while maximizing thermal contact area. These remaining L-shaped members 1050.50 of the main body 1056 appear positioned to surround or lie adjacent to the corners of the tooth or main body 1024 of the corresponding stator-support segment 1018 when assembled. The L-shaped members 1050.50 are designed to protect the windings 16 (which would be wound around this structure) from sharp corners or edges of the laminations of the stator-support segment 1018. Corner protection prevents insulation damage during winding and operation.

The apertures 1058 created by this material removal are specifically designed to be filled with the potting material 10 once the stator assembly (comprising segments 1018 and 1050 with windings 16) has been inserted or installed (e.g., hot dropped) into the actuator housing 4 and the potting process (step 114) is performed. The aperture design facilitates complete potting penetration. As described previously regarding the potting process, the potting material 10 may be effectively inserted into and fill these apertures 1058 due to the fact that the potting material 10 is added to the system under positive pressure (e.g., between 1 to 200 psi) or introduced under vacuum conditions (e.g., between 0.1 to 30 torr), which forces the liquid potting compound to penetrate voids and gaps. Pressure or vacuum application ensures thorough infiltration.

Unlike some conventional motor designs where the primary thermal conduction path between the heat-generating windings 16 and the heat-dissipating stator-support segment 1018 (and ultimately the housing 4) might only occur effectively near the outer edges (at the back iron or outer flange 1020) via the potting material 10, this alternative winding-carrier segment 1050 design aims to significantly increase the thermal contact area between the winding 16 and the stator-support segment 1018. Enhanced thermal coupling reduces operating temperatures. It achieves this by creating a new, direct thermal path between the winding 16 and the sides of the main body 1024 of the stator-support segment 1018 through the thermally conductive potting material 10 filling the apertures 1058. Direct thermal paths minimize thermal resistance. Thus, the effective thermal conduction path area between the winding 16 and the stator-support segment 1018 may be increased by any significant value, perhaps between 1% and 90% or more, depending on the specific amount and geometry of material that is removed from the sidewalls of the main body 1056 (i.e., defining the extent and shape of the apertures 1058) and also depending on the effectiveness of the pressure/vacuum applied during the potting process, which ensures that the potting material 10 thoroughly permeates through and around the windings 16 within these apertures. Thermal path optimization enables higher continuous power ratings.

Further embodiments may utilize advanced polymer systems for bonding or adhesion within the actuator 2 structure, offering targeted improvements beyond conventional materials. For instance, the adhesive 28 employed between the sheets 26 forming the stator-support segments 18, or the binder utilized in the creation of bonded permanent magnets 72 for the rotor 8, may comprise formulations specifically engineered for significantly enhanced thermal conductivity. Advanced adhesive formulations provide multifunctional benefits. Such thermally conductive adhesives, potentially incorporating fillers like boron nitride, aluminum nitride, or other ceramic particles while maintaining high dielectric strength, facilitate more efficient heat transfer away from the heat-generating laminations 26 (due to eddy currents and hysteresis losses) or magnets 72 (due to eddy currents) towards the housing 4. Enhanced heat transfer reduces component temperatures and improves reliability. This improved thermal pathway can lower the operating temperature of the stator 6 and rotor 8, potentially increasing motor 2.1 efficiency, extending component life, and allowing for higher continuous torque output. Temperature reduction directly correlates with performance improvements. Additionally, specialized polymer binders or adhesives 28 may be selected for their enhanced resistance to specific environmental factors anticipated in certain robotic applications, such as improved resistance to ionizing radiation for space or nuclear environments, or resilience against specific chemical agents present in industrial settings, thereby ensuring the structural integrity and insulating properties of the laminated stator segments 18 or the bonded magnets 72 over the operational life of the actuator 2.

In an alternative manufacturing methodology for the stator-support segments 18, the need for separate application of adhesive layers 28 between individual sheets 26 may be obviated through the use of electrical steel laminations pre-coated with specialized insulating layers possessing self-bonding characteristics. Pre-coated laminations streamline manufacturing processes. These pre-coated laminations feature a thin dielectric coating, often based on epoxy or phenolic resins blended with inorganic fillers, applied uniformly to the steel surface by the material supplier. Coating uniformity ensures consistent electrical insulation. Subsequent to the stamping or cutting of the individual sheet 26 profiles, the stack of sheets 26 forming a stator-support segment 18 is subjected to a controlled heating and pressure cycle. Process control ensures complete bonding activation. This process activates the resin within the coating, causing adjacent sheets 26 to permanently bond together while simultaneously ensuring robust electrical insulation between them, effectively inhibiting interlaminar eddy currents. Self-bonding eliminates separate adhesive application steps. Utilizing such self-bonding lamination coatings can streamline the assembly process (step 102), eliminate variability associated with manual or automated application of liquid or film adhesives 28, potentially improve the stacking factor (ratio of steel volume to total stack volume) for enhanced magnetic performance, and ensure highly consistent structural and insulative integrity within each stator-support segment 18, contributing to repeatable performance and reliability of the actuator 2.

To enhance the transient thermal management capabilities of the actuator 2, particularly during periods of peak power demand or intermittent high-load operation common in robotic tasks, embodiments may incorporate Phase Change Materials (PCMs). PCMs provide thermal buffering during transient operations. These materials are specifically selected to undergo a solid-to-liquid (or sometimes solid-to-solid) phase transition at a predetermined temperature relevant to the actuator's safe operating limits. Phase transition temperature selection optimizes thermal protection. The PCM may be strategically embedded within voids or dedicated cavities within the actuator housing 4, integrated into the potting material 10 surrounding the windings 16, or potentially incorporated within the structure of the stator 6 or rotor 8 components themselves. Strategic PCM placement maximizes effectiveness. During operation, as the actuator temperature approaches the PCM's transition temperature, the material absorbs significant amounts of latent heat during its phase change, effectively buffering temperature spikes without a corresponding large rise in its own temperature. Latent heat absorption provides thermal capacitance. This thermal energy storage capacity allows the actuator 2 to sustain higher peak torque outputs for longer durations or absorb repetitive transient heat loads more effectively, thereby stabilizing the temperature of components like the windings 16 and magnets 72, potentially preventing premature thermal degradation or demagnetization, and enhancing the overall robustness and peak performance envelope of the actuator. Thermal buffering extends peak power duration. Upon reduction of the heat load, the PCM resolidifies, releasing the stored latent heat gradually to the surrounding structure and environment.

Other embodiments may feature enhanced thermal management through direct cooling applied in immediate proximity to the primary heat source, namely the stator windings 16. Direct cooling reduces thermal resistance paths. Unlike relying solely on conduction through the potting material 10 and stator structure 6 to the housing 4, direct winding cooling methods aim to extract heat more effectively from the copper coils themselves. Targeted cooling improves efficiency. This may be achieved by incorporating specific internal channel designs directly within the stator-support segments 18 or winding-carrier segments 50, 1050, positioned adjacent to the winding slots. Channel geometry optimization balances cooling effectiveness and manufacturing complexity. These channels could circulate a liquid coolant (e.g., dielectric fluid, water-glycol mixture) or forced air directly past the windings 16 or the winding carrier structure. Coolant selection considers dielectric properties and thermal capacity. Alternatively, miniature heat pipes, potentially flattened or shaped to conform to the winding slot geometry, could be embedded within the stator teeth of the main body 24 or adjacent to the end windings, providing highly efficient passive heat transfer pathways to conduct heat away from the windings 16 towards an external heat sink integrated with the housing 4 or robot structure. Heat pipe integration provides passive, maintenance-free cooling. Such direct cooling approaches can significantly reduce winding temperatures, enabling higher current densities for increased torque output, improved efficiency by lowering resistive losses (I²R), and enhanced operational lifespan.

In certain embodiments requiring active thermal management or precision temperature control for optimal performance or protection of sensitive components, Thermoelectric Cooling (TEC) modules, also known as Peltier devices, may be strategically integrated within the actuator 2 structure. Active cooling enables operation beyond passive cooling limits. These solid-state devices utilize the Peltier effect to create a temperature difference when electrical current is applied, effectively pumping heat from one side to the other. Solid-state operation ensures reliability. TEC modules could be incorporated directly into the actuator housing 4, potentially positioned on the exterior surface near identified hotspots or integrated flush with internal surfaces adjacent to heat-generating components. Strategic TEC placement targets critical components. For instance, TECs might be thermally coupled to the back iron (outer flange 20) of the stator-support segments 18 to actively draw heat away from the stator 6 assembly, or potentially used for localized cooling of integrated control electronics or sensitive sensor elements housed within or near the actuator 2. Localized cooling protects temperature-sensitive components. While TECs introduce additional power consumption and require heat rejection from their hot side (often necessitating external fins or linkage to a broader thermal management system), their ability to provide active, below-ambient cooling in specific locations may be advantageous for improving or maximizing power density, ensuring the stability of permanent magnets 72 (particularly those with lower temperature ratings), or enabling operation in high ambient temperature environments.

As a highly efficient passive thermal management solution, embodiments of the actuator 2 may incorporate Oscillating Heat Pipes (OHPs), also known as Pulsating Heat Pipes. OHPs provide high heat flux capacity with no moving parts. OHPs consist of a meandering capillary tube structure filled with a specific working fluid. Working fluid selection optimizes operating temperature range. When a temperature difference is applied across the structure, the fluid undergoes localized boiling and condensation, creating pressure oscillations that drive a highly effective two-phase heat transfer mechanism along the tube length, exhibiting very high effective thermal conductivity without requiring external pumps or moving parts like traditional liquid cooling. Passive operation ensures reliability and eliminates maintenance. OHPs could be embedded within the stator-support ring 12, potentially running axially through or circumferentially within the back iron (outer flange 20) of the stator-support segments 18, or integrated directly into the walls of the actuator housing 4. Integration methods preserve structural integrity while maximizing thermal performance. By efficiently transferring heat from hotter regions (e.g., near the stator windings 16) to cooler regions (e.g., externally finned areas of the housing 4), OHPs can significantly enhance the heat dissipation capability of the actuator 2, potentially allowing for a more compact and lightweight design compared to achieving similar thermal performance with purely conductive solid materials or active liquid cooling systems, while offering reliability due to their passive nature.

In alternative embodiments, the motor 2.1 may be configured as a flux-modulated or Vernier permanent magnet machine, wherein the stator 6 and rotor 8 incorporate different numbers of poles and slots to create a magnetic gearing effect. In such embodiments, the stator-support segments 18 may be configured with a high number of slots (e.g., 36-72 slots), while the permanent magnets 72 on the rotor 8 are arranged to provide a different number of pole pairs (e.g., 4-8 pole pairs), creating a magnetic gear ratio between the electrical frequency and mechanical rotation frequency. The magnetic gearing effect enables the motor 2.1 to produce significantly higher torque density compared to conventional designs, potentially achieving 2-5 times the torque output for the same volume. This configuration may be particularly advantageous for actuators requiring high torque at low speeds, such as the hip flex actuators (J11) 720 or knee actuators (J14) 820, eliminating or reducing the gear reduction requirements. The windings 16 may be configured as concentrated windings around individual stator-support segments 18, and the winding-carrier segments 50 may be adapted to accommodate the modified flux paths. The magnetic gearing principle inherent in the Vernier design also provides inherent overload protection, as the magnetic coupling can slip under excessive torque conditions without mechanical damage.

In further alternative embodiments, the motor 2.1 may employ a transverse-flux machine (TFM) topology, wherein the magnetic flux paths are oriented perpendicular to the direction of motion, enabling three-dimensional flux paths that can achieve ultra-high torque density. Unlike the radial flux configuration shown in the illustrative embodiment, a TFM configuration would orient the laminations 26 of the stator-support segments 18 circumferentially rather than radially, with the main flux path extending axially through the tooth or main body 24 before crossing the air gap 15 to the rotor 8. The rotor 8 in such embodiments may comprise axially magnetized permanent magnets 72 arranged in a flux-concentrating configuration, potentially employing soft magnetic composite (SMC) pole pieces between magnets to shape the three-dimensional flux paths. The stator windings 16 would be configured as ring-type coils extending circumferentially around the stator 6, potentially eliminating the need for complex end-turn configurations. This topology can achieve torque densities exceeding 100 Nm/L, making it particularly suitable for space-constrained applications within the robot 1. The housing 4 may require modification to accommodate the altered flux paths and potentially increased axial length, while the thermally-conductive potting 10 would fill the unique void patterns created by the transverse-flux geometry.

In yet other embodiments, the motor 2.1 may utilize a flux-switching permanent magnet topology, wherein the permanent magnets 72 are relocated from the rotor 8 to the stator 6, being embedded within or between the stator-support segments 18. In such configurations, each stator-support segment 18 may be modified to incorporate slots or recesses for housing permanent magnet pieces, with the magnets 72 arranged to create alternating flux polarities in adjacent segments 18. The rotor 8 in flux-switching embodiments comprises a simple salient iron structure without permanent magnets, potentially formed from the same laminated construction using laminations 71 and adhesive layers 71.1 as described for the rotor-support ring 70, but configured with protruding poles rather than a smooth cylindrical surface. This configuration offers several advantages including: reduced rotor inertia due to the absence of rotor magnets, improved high-speed capability as centrifugal forces on magnets are eliminated, enhanced thermal management as heat-generating windings 16 and temperature-sensitive magnets 72 are both stationary and can be cooled through the housing 4, and potentially lower manufacturing costs for the rotor assembly. The winding-carrier segments 50 would be adapted to accommodate both the windings 16 and the stationary magnets 72, potentially incorporating additional channels or recesses for magnet retention.

Alternative embodiments may also implement a wound-field synchronous machine (WFSM) configuration, eliminating permanent magnets 72 entirely in favor of electromagnets created by field windings on the rotor 8. In such embodiments, the rotor 8 would incorporate a modified rotor-support ring 70 configured to carry field windings that generate the rotor magnetic field when energized with DC current. The DC current would be supplied to the rotating field windings through slip rings or a brushless exciter system integrated into the actuator 2. The stator 6 construction would remain substantially similar to the illustrated embodiment, with the stator-support segments 18, winding-carrier segments 50, and armature windings 16 functioning as described previously. This topology offers unique advantages including: field weakening capability for extended speed range operation without the demagnetization risks associated with permanent magnets 72, elimination of rare-earth materials for improved supply chain resilience and reduced cost, adjustable field strength for optimizing efficiency across different operating points, and inherent immunity to demagnetization from high temperatures or fault currents. The housing 4 may incorporate additional provisions for the slip ring assembly or brushless exciter, and the thermal management features would be adapted to dissipate heat from both the stator windings 16 and rotor field windings.

In additional alternative embodiments, the motor 2.1 may incorporate advanced sensing capabilities for fully sensorless control operation, eliminating the need for discrete position sensors through observer-based control algorithms or embedded thin-film flux sensors. For observer-based sensorless control, the motor 2.1 would rely on measurement of the back-EMF generated in the windings 16 and current feedback to estimate rotor position and speed through advanced signal processing algorithms implemented in the motor controller. Alternatively or additionally, thin-film magnetoresistive or Hall-effect sensors may be embedded directly within the winding-carrier segments 50 or deposited onto the inner surfaces thereof during manufacturing, providing distributed flux sensing throughout the stator 6. These embedded sensors would be connected through printed traces or flexible circuits integrated into the winding-carrier segments 50, potentially utilizing the same potting material 10 for environmental protection. The sensorless control capability eliminates mechanical position sensors that may be susceptible to vibration, contamination, or mechanical wear, improving overall actuator reliability. For the humanoid robot 1 application, sensorless control is particularly advantageous as it reduces wiring complexity, eliminates sensor alignment procedures during assembly, and provides inherent redundancy through the distributed sensing approach. The thin-film sensors, if employed, would be thermally stable to operate at the same temperature ranges as the windings 16 and would provide high-bandwidth flux measurements for advanced control strategies including predictive torque control and active vibration suppression.

ii. External Cover Assembly

The illustrative embodiment robot 1 includes various components (e.g., assemblies) with housings 1.2.2 (e.g., to form an exoskeleton) that are designed to protect the operational systems of the robot 1, such as actuators 1.2.4 and electronics assembly 1.2.6, provide structural support, and give form to the robot 1. Said housings 1.2.2 can be comprised of hard or rigid casings that may include internal mounting features designed to support systems in specific locations, structural features engineered to withstand operational loads, and internal and/or external features that allow for interoperation between adjacent components and/or are formed to resemble human features. Some housings 1.2.2 additionally include one or more detachable shells that may overlay a casing to allow access to internal assemblies or to complete the form of the component.

The requirements of the housings 1.2.2 can vary in shape and form based on the individual structural or material requirements for each specific component. While it may be desirable to utilize a particular material for all housings 1.2.2 to create a consistent exterior appearance, fabrication may be complicated by specific structural or operational needs at different locations. It may not be necessary to utilize the same materials in different housings 1.2.2 that experience different load requirements. Various materials may be preferred for a specific housing 1.2.2 based on properties such as strength, toughness, elasticity, weight, and conductivity. Similarly, the complexity of some housing 1.2.2 designs may be better suited for one type of manufacturing process, such as machining, die casting, injection molding, or composite fabrication, over another. Because there is a desire or need to use different materials within different regions and/or use materials that do not have a consistent exterior appearance, the illustrative embodiment robot 1 includes exterior coverings of the exterior covering assembly 1.2.16 that are designed to at least partially hide the housings 1.2.2 under a textile exterior layer that can be easily swapped if damaged, serve to protect internal components from dust and debris, are designed to fit the form of the robot 1 without substantial wrinkling, and/or allow for venting or address thermal considerations at specified locations.

The exterior coverings may have a multi-layered assembly, which may include: (i) an energy-absorbing material that is coupled to the coupling layer, (ii) a coupling layer (e.g., plastic or polymer based), wherein the coupling layer facilitates attachment to, or attachment at, a housing 1.2.2, and/or (iii) an exterior coverings material (e.g., a textile). Alternatively, the multi-layered assembly may omit the coupling layer, the energy-absorbing material, and/or exterior covering material. In each case, the movement of the nearby joint may cause one housing 1.2.2 to impact or crush the energy absorbing layer instead of another housing 1.2.2, thereby mitigating or eliminating structural stress or load on either housing 1.2.2 and/or the respective actuator 1.2.4. Additionally, the energy attenuation members help to reduce pinch points, and/or allow for a more human-like appearance.

### 1. Energy Attenuation Assembly

The energy attenuation assembly may be composed of a plurality of integrated or removable energy attenuation members, such as pads, panels, or bumpers, that are attached to housings 1.2.2 of the robot 1 and/or are positioned within the external covers. Said energy attenuation members may: (i) be attached directly to a particular exterior side of a housing 1.2.2 (e.g., overlie the housing), (ii) surround an exterior of a housing 1.2.2 and not be directly attached (e.g., friction fit), (iii) be attached to the edges of an opening formed in the housing 1.2.2 (e.g., act as a deformational extent of the housing), and/or (iv) be attached to or retained by the exterior coverings.

The disclosed robot 1 includes a torso energy attenuation member, elbow energy attenuation members, and leg energy attenuation members. Additionally, energy attenuation members may be included at the hip, shin, and/or foot. Some or all energy attenuation members may also be omitted. Energy attenuation members can be configured to enhance or alter the shape of the robot 1 without adding substantial weight and to provide a deformable structure with energy absorption properties to protect underlying components.

The energy attenuation members can be made from a wide variety of materials, including: (i) polymers, such as polyethylene foam (PE Foam), ethylene vinyl acetate (EVA) foam, polyurethane foam (including Memory Foam and Open-cell Polyurethane Foam); (ii) rubber foams; (iii) natural foams; (iv) engineered foams; (v) composite and hybrid materials; (vi) expanded polystyrene (EPS); (vii) expanded polypropylene (EPP); (viii) Koroyd®; (ix) D3O®; (x) Poron® XRD; (xi) thermoplastic elastomers (TPE) or thermoplastic polyurethane (TPU); (xii) any other material known to one of skill in the art that accomplishes the desired energy absorption characteristics; (xiii) any combination of the above. Furthermore, the energy-absorbing material may alternatively or additionally include other structures of said materials, wherein said structures may include lattices and/or repeating units, such as a cube, sphere, cylinder, cone, pyramid, torus, prism, tetrahedron, dodecahedron, octahedron, icosahedron, ellipsoid, paraboloid, cuboid, or hexahedron. It should be understood that the repeating unit or lattice cell may be contained in a specific region or may propagate throughout the entire energy attenuation member. Additionally, the energy attenuation members and/or the assembly may have varying properties, such as thickness, density, C/D ratio, and stiffness. This variation may be arranged in a gradient manner, wherein the energy-absorbing materials transition from softer to firmer layers or regions to provide progressive energy dissipation.

### 2. Exterior Coverings

The exterior coverings, which can include a neck cover, a torso cover, an upper leg cover, a shin cover, a foot cover, a lower arm cover, and a hand cover, are designed not to interfere with the robot's range of motion, to allow access to underlying components, to potentially add indicators to the external surface, and to improve the robot's overall aesthetic appearance. As shown in the figures, a single exterior covering does not extend over all actuators in the robot 1, and typically does not cover more than five actuators at a time. In other words, the exterior covering does not resemble an oversized jumpsuit with a closure running from, e.g., the robot's pelvis to its head region, nor does it include a hood that extends around a substantial portion of the robot's head. Instead, the exterior covering is strategically and tightly fitted in certain regions and may include different inserts (e.g., a different textile) that are positioned between the moving aspects of joints.

Exterior coverings materials of the exterior covering assembly 1.2.16 can be made from one or more textiles and can be customized or selected to reduce wrinkling and to allow for the twisting or movement of the underlying components without restriction or substantial distortion. For example, the exterior coverings materials may be designed to allow the lower arm to twist and rotate from about-120 degrees to about 180 degrees. Additionally, the exterior coverings materials may be selected to allow for the cooling of components, the viewing of indicator lights, or the operation of buttons through said exterior coverings. This provides a substantial benefit over conventional systems that lack these advanced features. It should be understood that this disclosure contemplates using or including exterior coverings materials that: (i) integrate lights from the robot 1 into said exterior covering, and specifically into a textile itself, (ii) may be translucent or temporarily translucent (e.g., based on time or environment), and/or (iii) can be formed (e.g., woven) in a manner that allows light to be transmitted through the textile.

As such, various types of lights (e.g., fiber optic lighting, led strip lights, led rope lights, micro-led string lights, led neon flex, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials, electroluminescent paint, laser-illuminated fiber bunches, phosphor-coated electroluminescent (PCEL) materials, smart RGB led strips, light-up silicone tubing (LED or EL-based), laser wire, or other electroluminescent materials such as EL wire, EL tape, or EL film) that are coupled to the humanoid robot 1 may be visible through the exterior coverings material. The exterior coverings material can include reflective yarn or night-luminous yarn that changes its appearance when light is shining on its surface. In other embodiments, a shiny, reflective, iridescent, matte, or textured polyurethane film can be applied to the surface of the exterior coverings material (e.g., a textile) in certain areas to provide an additional reflective effect or for another purpose, such as displaying a logo, pattern, or labels.

The exterior coverings material can also include features to accommodate the thermal considerations of the robot 1. In various examples, the exterior coverings material can be a custom textile that utilize different weaves in different locations to allow for ventilation in specific areas. Additionally, the exterior coverings material can include textiles or threads that are heat-sensitive and change color with a change in temperature. In summary, the exterior coverings may additionally be made from, include, or specifically omit any one or any combination of the following material types: durable materials, flame-resistant materials, waterproof materials, hazard materials, chemical-resistant materials.

Alternatively or additionally, the exterior covering assembly 1.2.16 may include features such as closures (e.g., a zipper that runs a partial or full length of the exterior covering assembly 1.2.16), attachment points, couplers, self-cleaning nanocoatings, thermoelectric materials, photochromic dyes, or electromagnetic shielding layers, as well as modular, quick-release panels or e-textile technology with conductive fibers woven throughout to create a distributed sensor network that is capable of detecting impacts, monitoring joint angles, or even harvesting energy from movement. The exterior covering assembly 1.2.16 may be designed to include inserts (which may also be textiles or may be other materials) that are positioned strategically between moving joint components to further ensure that pivoting motion is not restricted at the joints of the humanoid robot 1. Different textile materials, patterns, knits, weaves, etc. may be incorporated to facilitate movement in specific regions, thereby enhancing the functional dexterity of the robot 1.

iii. Sensors

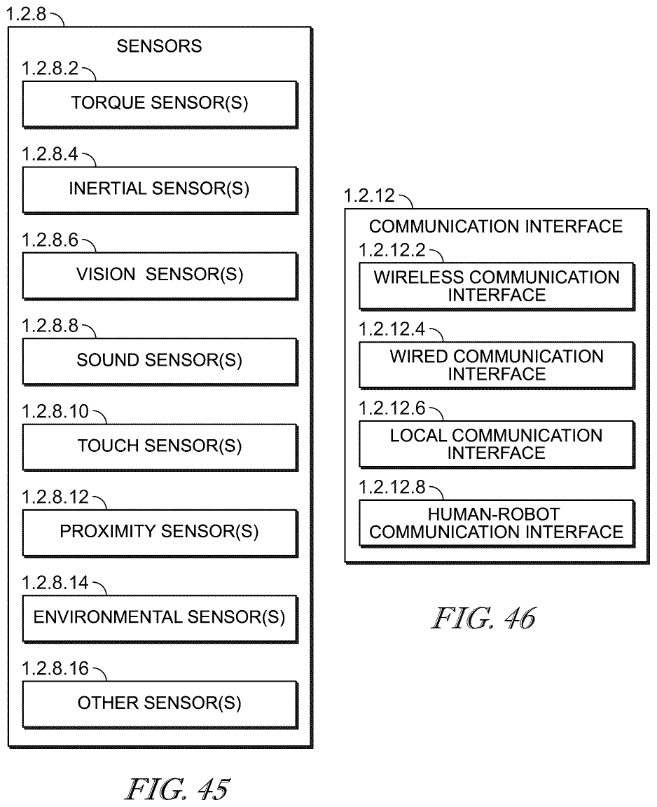

As illustrated in FIG. 45, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, visual sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iv. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 46 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Referring to FIG. 46, examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

v. Data Storage

Referring back to FIG. 2, the data storage 1.2.14 may be embodied as any hardware, software, or circuitry for storing, retrieving, and maintaining data for the humanoid robot 1. More particularly, the data storage 1.2.14 may be embodied as any type of device configured for short-term or long-term storage of data. The data storage 1.2.14 may be embodied as memory devices and circuits, solid state drives (SSDs), memory cards, hard disk drives, USB flash drives, or other data storage devices. The data storage 1.2.14 can be embodied as one or more SSDs that expose internal parallelism to components of the humanoid robot 1, allowing the humanoid robot 1, for example, via the compute 1000, to perform storage operations on the data storage 1.2.14 in parallel.

The data storage 1.2.14 may also include memory devices, which may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards, and similar standards, may be referred to as DDR-based standards and communication interfaces of the storage devices that implement such standards may be referred to as DDR-based interfaces.

The memory device is a block addressable memory device, such as those based on NAND or NOR technologies. A memory device may also include a three dimensional crosspoint memory device (e.g., Intel® 3D XPoint® memory), or other byte addressable write-in-place nonvolatile memory devices. In an embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the device itself and/or to a packaged memory product. For data storage 1.2.14, a hierarchical storage architecture may be employed, using faster, smaller caches for frequently accessed data and larger, slower storage for archival or less critical data, optimizing both speed and capacity.

### E. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 may be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 18/922,334, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/324,392, 19/325,486, 19/325,415, and 19/324,342; and (iii) U.S. Design patents application Ser. Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A humanoid robot comprising:
a humanoid shape including a torso, an arm, and a leg; and
an actuator configured to actuate at least a portion of the torso, arm, or leg of the humanoid robot, the actuator comprising:
a motor having a central axis and an outer diameter surrounding the central axis, the motor comprising:
(A) a stator comprising:
(i) a stator-support ring comprising a plurality of stator-support segments, wherein at least one stator-support segment of the plurality of stator-support segments comprises a stacked layup of laminations interleaved with layers of adhesive, wherein the laminations lack holes formed therethrough,
(ii) a winding-carrier ring comprising a plurality of winding-carrier segments, wherein each winding-carrier segment corresponds to a stator-support segment of the plurality of stator-support segments,
(iii) a collection of electrical windings, each electrical winding corresponding to a winding-carrier segment of the plurality of winding-carrier segments and comprising a coil of conductive wire arranged about a portion of the corresponding stator-support segment of the plurality of stator-support segments, and
(B) a rotor positioned within the stator and configured to rotate therein about the central axis, wherein the rotor comprises magnets;
an actuator housing having an inner diameter that is smaller than the outer diameter of the motor at ambient temperature when the motor is not installed in the actuator housing; and
a thermally-conductive potting that fills a majority of voids between the stator and the housing.

2. The humanoid robot of claim 1, wherein the stacked layup lacks holes formed therethrough.

3. The humanoid robot of claim 1, wherein at least some of the laminations of the stacked layup are stacked in a depthwise direction along the central axis of the motor.

4. The humanoid robot of claim 1, wherein at least some of the laminations of the stacked layup are stacked in a radial arrangement about the central axis of the motor.

5. The humanoid robot of claim 1, wherein at least some of the laminations of the stacked layup are stacked in a flat plane arrangement in a direction concentrically outward from the central axis of the motor.

6. The humanoid robot of claim 1, wherein at least some of the laminations of the stacked layup are stacked in a curved plane arrangement in a direction concentrically outward from the central axis of the motor.

7. The humanoid robot of claim 1, wherein each lamination of the stacked layup of laminations is the identical shape.

8. The humanoid robot of claim 1, wherein the motor provides a momentary peak torque of between 15 N-m and 307 N-m and has an outer diameter of substantially 68 mm.

9. The humanoid robot of claim 1, wherein the outer diameter of the motor comprises the outer diameter of the stator.

10. The humanoid robot of claim 1, wherein the plurality of stator-support segments are joined circumferentially around the central axis and the plurality of stator-support segments are joined via laser welds at exterior joint extents between neighboring stator-support segments of the plurality of stator-support segments.

11. The humanoid robot of claim 1, wherein the stator-support ring is arranged as an annular ring and formed from an assembly of physically separate stator-support segments which comprise the plurality of stator-support segments.

12. The humanoid robot of claim 1, wherein at least one winding-carrier segment of the plurality of winding-carrier segments includes a throughhole through which the at least one stator-support segment of the plurality of stator-support segments could be received into and pass through during assembly of the motor.

13. The humanoid robot of claim 12, wherein the at least one winding-carrier segment of the plurality of winding-carrier segments further includes an outer cap, an inner cap, and a main body, wherein the through hole is substantially 75% of a height of the main body between the outer cap and the inner cap, and is substantially 20% of the width of the main body.

14. The humanoid robot of claim 1, wherein the thermally-conductive potting forms a thermal path between the collection of electrical windings and the plurality of stator-support segments.

15. The humanoid robot of claim 1, wherein each stator-support segment of the plurality of stator-support segments comprises a protrusion extending circumferentially from a first side of the stator-support segment and a recess conforming to a shape of the protrusion formed into a second side of the stator-support segment opposing the first side of the stator-support segment.

16. The humanoid robot of claim 1, wherein at least one winding-carrier segment of the plurality of winding-carrier segments has a patterned surface conforming to at least a portion of the coil of conductive wire and configured to guide placement of the conductive wire.

17. A humanoid robot comprising:
a humanoid shape including a torso, arms, and legs; and
an actuator configured to actuate a component of the humanoid robot, the actuator comprising:
a motor having a central axis and an outer diameter surrounding the central axis, the motor comprising:
(A) a stator comprising:
(i) a stator-support ring comprising a plurality of stator-support segments, wherein each stator-support segment of the plurality of stator-support segments comprises:
a protrusion extending circumferentially from the stator-support segment and configured to be received by a neighboring recess formed in a first adjacent stator-support segment, and
a recess configured to receive a neighboring protrusion that extends circumferentially from a second adjacent stator-support segment,
(ii) a winding-carrier ring comprising a plurality of winding-carrier segments, wherein each winding-carrier segment corresponds to a stator-support segment of the plurality of stator-support segments,
(iii) a collection of electrical windings, each electrical winding corresponding to a winding-carrier segment of the plurality of winding-carrier segments and comprising a coil of conductive wire arranged about a portion of the corresponding stator-support segment of the plurality of stator-support segments, and
(B) a rotor positioned within the stator and configured to rotate therein about the central axis, wherein the rotor comprises magnets;
an actuator housing surrounding at least a portion of the motor and wherein an interference fit is formed between the housing and the motor when the motor is installed in the housing; and
a thermally-conductive potting that fills a majority of voids between the stator and the housing.

18. The humanoid robot of claim 17, wherein each stator-support segment of the plurality of stator-support segments further comprises an outer flange, an inner flange spaced radially inward from the outer flange relative to the central axis, and a main body extending radially between and interconnecting the outer flange and the inner flange, and wherein each protrusion extends circumferentially from the outer flange of each stator-support segment of the plurality of stator-support segments, and wherein each recess is formed in the outer flange of each stator-support segment of the plurality of stator-support segments.

19. The humanoid robot of claim 17, wherein the protrusion additionally extends axially along an axial length of each stator-support segment of the plurality of stator-support segments at the location of the protrusion.

20. The humanoid robot of claim 17, wherein the recess extends axially along an axial length of each stator-support segment of the plurality of stator-support segments at the location of the recess.

21. The humanoid robot of claim 17, wherein each stator-support segment of the plurality of stator-support segments further comprises a first circumferential side wall from which the protrusion extends and a second circumferential side wall into which the recess is formed, wherein the protrusion and first circumferential side wall cooperate with the neighboring recess formed in a neighboring second circumferential side wall of the first adjacent stator-support segment to mitigate movement of the stator-support segment relative to the first adjacent stator-support segment in both a radial direction and circumferential direction.

22. The humanoid robot of claim 17, wherein the protrusion and the neighboring recess formed in the first adjacent stator-support segment share a mating profile along an axial length of the protrusion.

23. The humanoid robot of claim 17, wherein the plurality of stator-support segments are joined circumferentially around the central axis and the plurality of stator-support segments are joined via laser welds at exterior joint extents between neighboring stator-support segments of the plurality of stator-support segments.

24. The humanoid robot of claim 17, wherein each stator-support segment of the plurality of stator-support segments lacks any holes formed therethrough.

25. The humanoid robot of claim 17, wherein the actuator housing comprises an aluminum alloy and the stator comprises a laminated silicon steel, and wherein a coefficient of thermal expansion (“CTE”) of the stator is less than a CTE of the actuator housing.

26. The humanoid robot of claim 17, wherein each stator-support segment of the plurality of stator-support segments comprises a stacked layup of laminations interleaved with layers of adhesive, wherein the laminations of the stacked layup are stacked in a depthwise direction along the central axis of the motor.

27. The humanoid robot of claim 17, wherein at least one winding-carrier segment of the plurality of winding-carrier segments further includes an outer cap, an inner cap, and a main body, wherein the through hole is at least 75% of a height of the main body between the outer cap and the inner cap, and is at least 20% of the width of the main body.

28. The humanoid robot of claim 17, wherein at least one winding-carrier segment of the plurality of winding-carrier segments has a patterned surface conforming to at least a portion of the coil of conductive wire and configured to guide placement of the conductive wire.

29. The humanoid robot of claim 17, wherein the thermally-conductive potting forms a thermal path between the collection of electrical windings and the plurality of stator-support segments.
